(19) United States
(12) Patent Application Publication
(10) Pub. No.: US 2007/0031801 A1
(43) Pub. Date: Feb. 8, 2007

(54) Patterned response system and method

(75) Inventors: Sylvia Tidwell-Scheuring, Carmel, CA (US); Joshua Marks, Aptos, CA (US); Mani Radha, Salinas, CA (US); Roger Creamer, Pacific Grove, CA (US)

Correspondence Address: ROTHWELL, FIGG, ERNST & MANBECK, P.C., 1425 K STREET, N.W., SUITE 800, WASHINGTON, DC, 20005, US

(73) Assignee: CTB McGraw Hill, Monterey, CA (US)

(21) Appl. No.: 11/454,113

(22) Filed: Jun. 16, 2006

Related U.S. Application Data
(60) Provisional application No. 60/691,957, filed on Jun. 16, 2005.

(51) Int. Cl. G09B 3/00; G09B 7/00

(52) U.S. Cl. 434/322; 434/362

(57) ABSTRACT

A patterned response system and method provide for automatically, e.g., programmatically, generating learning items that are useable in conjunction with an assessment. In one embodiment, the learning items may be generated as an aggregation of patterns corresponding to a targeted skill and related skills. The relatedness of skills may, for example, be determined according to a precursor/postcursor based learning relationship that may be represented by a learning map.

This application claims the benefit of U.S. Provisional Application Ser. No. 60/691,957 filed Jun. 16, 2005, the contents of which are hereby incorporated by reference.

### BACKGROUND OF THE INVENTION

1. Field of Invention

The present invention relates in general to the field of education and more specifically to systems and methods for performing student assessment.

2. Description of the Background Art

Accurate learning assessment is extremely important to all involved. Assessment results may, for example, determine whether persons being assessed will advance, enter a learning institution, find a job or secure a promotion. Results may affect learning provider funding, job security, and so on. Results may also affect assessment authority ranking, ability to attract students, workers or families, and so on, for assessment authorities such as states, institutions or sub-divisions. Results may further demonstrate the ability of assessment providers to verify and validate accurate assessment, which may determine whether such providers will attract customers, suffer legal liability, and so on. Nevertheless, the production and evaluation of assessments remain daunting tasks, the repeatable accuracy and complete utilization of which may now be drawn into question.

Conventional assessment, for example, provides for administering tests that are designed to assess an encapsulation of each student skill that is targeted for testing according to some standard imposed by a corresponding authority. Traditionally, tests were manually prepared by human experts referred to as subject matter experts (SMEs) who generated test items that included (and continue to include) questions and corresponding responses. The SMEs prepared the test items (items) according to the SMEs' experience in assessing a particular skill, or further according to corresponding performance information gleaned from prior testing and/or sample testing of the same or like items prior to testing actual test subjects. The test was then compiled, the actual test subjects (students) were tested and the students' responses were manually graded as correct or incorrect. A raw student score was then produced from the determined number of correct and/or incorrect responses of a student, and a comparative score or standard measure was produced from the raw score.

The massive task of manually grading large numbers of items for each of potentially thousands of students necessitated a primary use of items having student-selectable responses (“selected-response items”). However, short answer, essay or other item types were also manually generated in a similar manner by the SMEs. Such item types or portions thereof were further graded much like the selected-response items. Each item or item-subpart was scored as either correct (e.g., determined to include an expected response provided in a delineated manner by the student) or otherwise incorrect. A raw score was further calculated according to the correct, incorrect or combined total, and a comparative score or standard measure was produced from the raw score.

More recently, computers have been used to facilitate the tasks of creating and grading tests. For example, test items created by SMEs, as well as the above noted performance information are increasingly stored on a computer. Performance information may, for example, include—for a particular item or overall subject—raw/modified scores for particular students or groups of students, teaching syllabus/guidelines, demographics and the like. An SME manually preparing an item may therefore more easily examine the performance information for determining a skill to be tested. The SME may further select from one or more stored test items corresponding to the skill, and may generate a wholly new item or modify the stored test item(s) in order to generate one or more new items. Alternatively, a computer may be used to modify selected items according to provided performance information. Automated scoring is further readily used for scoring selected-response items (e.g., identifying delineated shaded circles on an answer sheet). The present inventor has also determined mechanisms for grading or further assessing these and/or other item types.

Unfortunately, factors that may be used to produce truly effective assessment of student learning are only now becoming evident through the emergence of greater processing capability and utilization of such capability by mechanisms such as the present invention. It is found, for example, that the experiential subjectivity, limited resources and prior unavailability of learning aspects (e.g., provided by the present invention) may result in items that may otherwise be better utilized for testing the same or even a broader range of skills, and with a substantially higher degree of assessment accuracy and utilization. Conventional automated or semi-automated assessment mechanisms, being subject to conventionally available SME provided data, selection and utilization limitations, are also necessarily incapable of overcoming such problems. Such mechanisms are also limited by the prior unavailability of processing reduction and accuracy improvement capabilities, such as those provided by the present invention, among still further problems.

Accordingly, there is a need for patterned response systems and methods that enable one or more of the above and/or other problems of conventional assessment to be avoided.

### SUMMARY OF EMBODIMENTS OF THE INVENTION

Embodiments of the present invention provide systems and methods for automatically or semi-automatically generating or facilitating assessment of one or more assessment items including patterned responses (e.g., programmatically or in conjunction with user intervention), thereby enabling problems of conventional mechanisms to be avoided and/or further advantages to be achieved. Assessment items may, for example, include selected response, graphing, matching, short answer, essay, other constrained constructed response items, other multimedia, gaming, performance of a job/educational function, performance of other assessable subject (student) actions or inactions, e.g., outside a more conventional written test taking paradigm, or substantially any other stimulus for producing an assessable student response. While targeted at one or more human students or student groups, a student may more generally include one or more of persons, other living organisms, devices, and so on, or some combination. Aspects of the present invention may also be utilized to generate, deploy or implement static, interactive or other learning, learning materials, observation, scoring, evaluation, and so on, among other uses, which aspects may also be conducted locally or remotely using electronic, hardcopy or other media, or some combination. Other examples will also become apparent to those skilled in the art.

Various embodiments provide for automatic or user assistable/verifiable determination of included skills to be assessed (target skills) in conjunction with at least a current assessment item. Such determination may, for example, be conducted according to a target skill and probabilistic or actual teaching/learning relationships between the target skill and one or more related skills (e.g., according to pre/post curser teachable concept criteria of a learning map). Skills may further be determined as corresponding to a student group portion, prior assessment/learning order, time, relatedness, degree of knowledge, other criteria or some combination of skill determining criteria. Skills that may be implicitly assessed may also be determined according to such factors, and may also be included, excluded or combined with explicit assessment, thereby enabling skill assessment to optimize the assessment value of included items.

Embodiments further provide for automatic or user assisted/verifiable determination of assessment item portions corresponding to the determined target skills. In one embodiment, item portions may be determined to include those target skills that correspond with an aggregate of skill, constraint and presentation criteria (“patterns”). One more specific embodiment provides for relaxing one or more of the applicable criteria where a sufficient number of item portions (e.g., presented and/or not presented or “hidden” responses) may not be determined to meet the aggregate of criteria according to at least one predetermined criteria or other condition (e.g., processing time). Another embodiment provides for removing item portions that represent skills for which now relaxed critical criteria corresponding to the skill are no longer applicable, for determining that a less accurate assessment may result, or for providing an SME or other user(s) alert as to the removing, a potentially or actually less accurate assessment that may result, causation, and so on, or some combination.

Embodiments also provide for conducting further refinement of included item portions or represented skills. One embodiment, for example, provides for determining assessment skill refinement criteria, and for removing or otherwise modifying one or more remaining item portions according to the determined criteria. Such refinement may, for example, include but is not limited to demographic, learning, experiential or other student/student group criteria as may be gleaned from historical, statistical, analytical or other information (e.g., proper nouns, colors, infirmities, beliefs, suitable actions, and so on), and/or may include assessment criteria including but not limited to continuity, differentiation or other prior, concurrent or future separable or accumulate-able (e.g., summative) assessment criteria.

Embodiments still further provide for documenting and/or alerting one or more of SMEs, assessor systems/users, authorities or other users as to item portions, processing, successful/unsuccessful item portion generation, and so on, or some combination, or further, for receiving and/or documenting corresponding user input.

A patterned response method according to an embodiment of the invention includes determining item generating criteria, and determining a target skill and related skills corresponding to the item generating criteria and a learning order relationship. The item generating criteria may, for example, include determined item patterns for a target skill and one or more related skills, and the learning order relationship may, for example, correspond to precursor and postcursor relationships, or further one or more degrees of relatedness and/or depths of knowledge of the skills. The method further includes determining, or generating, a preliminary item pattern expression corresponding to the target skill and the related skills, and resolving the preliminary item pattern expression to form a resolved item pattern expression. The method may further include resolving dynamic content of the item pattern expression and refining item pattern expression content according to at least one of student-based refinement criteria, student group-based refinement criteria and assessment-based refinement criteria to form an item instance.

A patterned response system according to an embodiment of the invention includes coupled devices including a skill determining engine for determining a target skill and related skills according to a learning order relationship, a skill expression engine, a content engine, and a learning map.

Another patterned response system according to an embodiment of the invention includes means for determining item generating criteria, and means for determining a target skill and related skills corresponding to the item generating criteria and a learning order relationship (e.g., a probabilistic learning order determined by reference to a corresponding learning map portion). The system also includes means for determining an item pattern expression corresponding to the target skill and the related skills, and means for resolving the cumulative item pattern expression to form a resolved item pattern expression. The system may further include means for refining item pattern expression content according to at least one of student-based refinement criteria, student group-based refinement criteria and assessment-based refinement criteria to form an item instance.

A patterned response management apparatus according to an embodiment of the invention provides a machine-readable medium having stored thereon instructions for determining item generating criteria, determining a target skill and related skills corresponding to the item generating criteria and a learning order relationship, and determining a cumulative item pattern expression corresponding to the target skill and the related skills. The instructions further include instructions for resolving the cumulative item portion expression to form a resolved item pattern expression, and may include instructions for refining the item pattern expression content (or resolved content) according to at least one of student-based refinement criteria, student group-based refinement criteria and assessment-based refinement criteria to form an item instance.

Advantageously, patterned response system and method embodiments according to the invention enable one or more items to be created and/or assessed in an efficient, robust, more accurate and repeatable manner and that may be conducted automatically and readily validated.

These provisions together with the various ancillary provisions and features which will become apparent to those artisans possessing skill in the art as the following description proceeds are attained by devices, assemblies, systems and methods of embodiments of the present invention, various embodiments thereof being shown with reference to the accompanying drawings, by way of example only, wherein:

### BRIEF DESCRIPTION OF THE DRAWINGS

FIG. 1a is a flow diagram illustrating a patterned response system according to an embodiment of the invention;

FIG. 1b is a flow diagram illustrating a further patterned response system according to an embodiment of the invention;

FIG. 2a illustrates a learning map useable in conjunction with the patterned response systems of FIGS. 1a and 1b, according to an embodiment of the invention;

FIG. 2b illustrates another learning map example according to an embodiment of the invention;

FIG. 3a illustrates a further learning map example in which the item patterns of FIG. 2b are shown in greater detail, according to an embodiment of the invention;

FIG. 3b illustrates an example of target/related skill determining according to an embodiment of the invention;

FIG. 3c illustrates an example of item pattern determining according to an embodiment of the invention;

FIG. 3d illustrates an example of an item pattern implementation according to an embodiment of the invention;

FIG. 4 is a schematic diagram illustrating an exemplary computing system including one or more of the cumulative assessment systems of FIGS. 1a or 1b, according to an embodiment of the invention;

FIG. 5a illustrates a pattern determining engine according to an embodiment of the invention;

FIG. 5b illustrates a content determining engine according to an embodiment of the invention;

FIG. 6 is a flowchart illustrating a patterned response generating method according to an embodiment of the invention;

FIG. 7a is a flowchart illustrating a portion of another patterned response generating method according to an embodiment of the invention;

FIG. 7b is a continuation of the flowchart beginning with FIG. 7a, according to an embodiment of the invention;

FIG. 7c is a continuation of the flowchart beginning with FIG. 7a, according to an embodiment of the invention;

FIG. 8 is a flowchart illustrating block 722 of FIG. 7b in greater detail, according to an embodiment of the invention; and

FIG. 9 is a flowchart illustrating block 742 of FIG. 7c in greater detail, according to an embodiment of the invention.

### DETAILED DESCRIPTION OF EMBODIMENTS OF THE INVENTION

In the description herein for embodiments of the present invention, numerous specific details are provided, such as examples of components and/or methods, to provide a thorough understanding of embodiments of the present invention. One skilled in the relevant art will recognize, however, that an embodiment of the invention may be practiced without one or more of the specific details, or with other apparatus, systems, assemblies, methods, components, materials, parts, and/or the like. In other instances, well-known structures, materials or operations are not specifically shown or described in detail to avoid obscuring aspects of embodiments of the present invention.

A “computer” for purposes of embodiments of the present invention may include any processor-containing device, such as a mainframe computer, personal computer, laptop, notebook, microcomputer, server, personal data assistant or “PDA” (also referred to as a personal information manager or “PIM”) smart cellular or other phone, so-called smart card, settop box or any of the like. A “computer program” may include any suitable locally or remotely executable program or sequence of coded instructions which are to be inserted into a computer. Stated more specifically, a computer program includes an organized collection of instructions that, when executed, causes the computer to behave in a predetermined manner. A computer program contains a collection of ingredients (called variables) and a collection of directions (called statements) that tell the computer what to do with the variables. The variables may represent numeric data, text, audio, graphical images, other multimedia information or combinations thereof. If a computer is employed for synchronously presenting multiple video program ID streams, such as on a display screen of the computer, the computer would have suitable instructions (e.g., source code) for allowing a user to synchronously display multiple video program ID streams in accordance with the embodiments of the present invention. Similarly, if a computer is employed for presenting other media via a suitable directly or indirectly coupled input/output (I/O) device, the computer would have suitable instructions for allowing a user to input or output (e.g., present) program code and/or data information respectively in accordance with the embodiments of the present invention.

A “computer-readable medium” for purposes of embodiments of the present invention may be any medium that may contain, store, communicate, propagate, or transport the computer program for use by or in connection with the instruction execution system, apparatus, system or device. The computer readable medium may be, by way of example only but not by limitation, an electronic, magnetic, optical, electromagnetic, infrared, or semiconductor system, apparatus, system, device, propagation medium, or computer memory. The computer readable medium may have suitable instructions for synchronously presenting multiple video program ID streams, such as on a display screen, or for providing for input or presenting in accordance with various embodiments of the present invention.

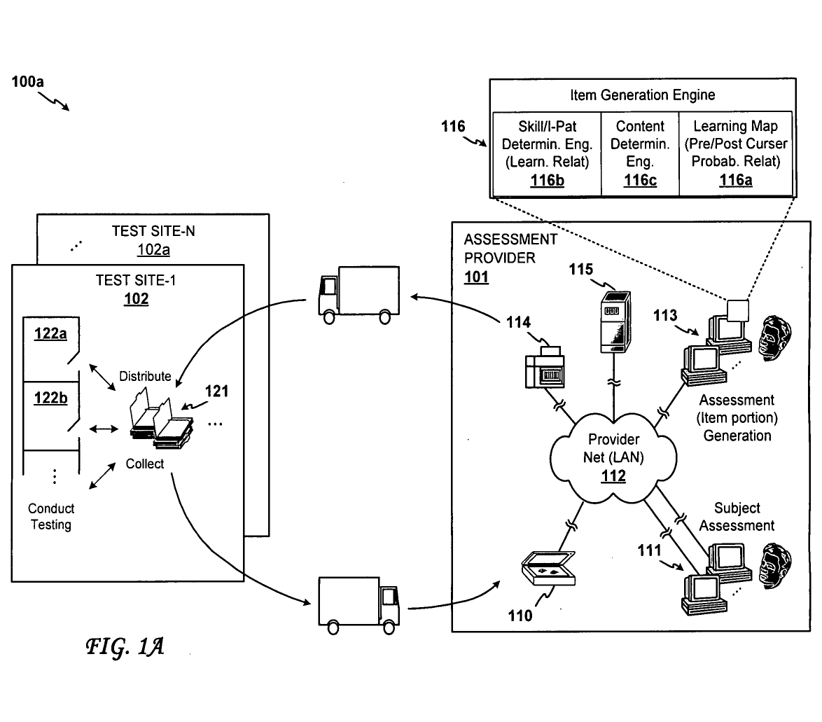

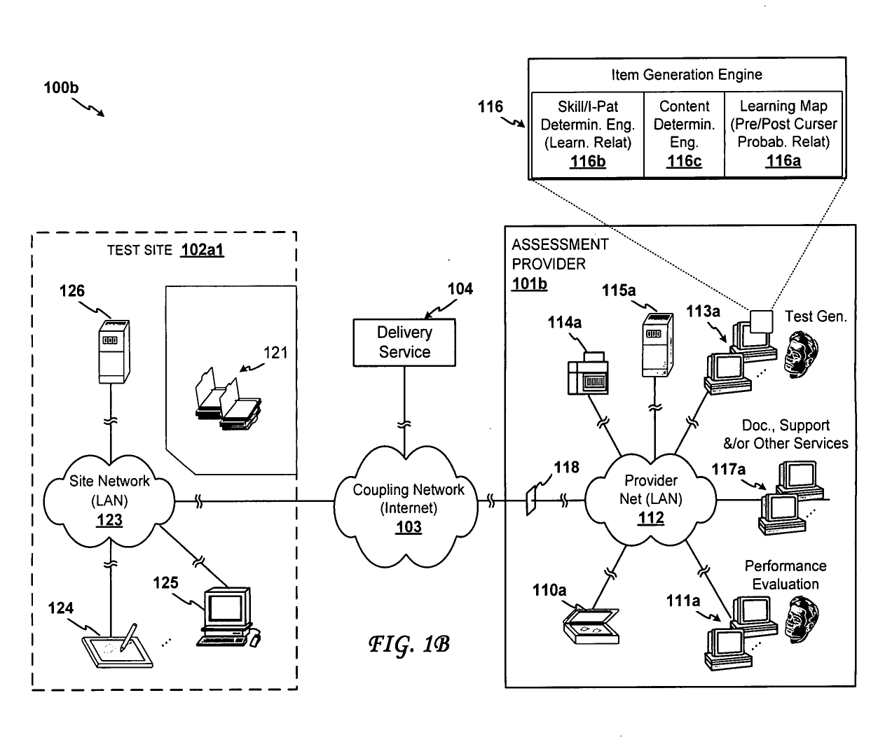

Referring now to FIG. 1a, there is seen a flow diagram illustrating a patterned response system 100a according to an embodiment of the invention. Patterned response system 100a broadly provides for generating one or more assessment portions (e.g., assessment items) useable in assessing an assessment subject (“student”) or subject group (“student group”). System 100a may further provide for forming an assessment or for facilitating a corresponding assessment or utilizing assessment results, for example, by generating expectable assessment results, item generation information, learning curricula, learning materials, and so on, or some combination.

An assessment may, for example, include but is not limited to one or more of formative, summative or other testing, educational or other gaming, homework or other assigned or assumed tasks, assessable business or other life occurrences or activities, and so on, the performance of which may be evaluated, scored, otherwise assessed or some combination. More typical assessments that may utilize one or more items producible by system 100a may, for example, include but are not limited to performance assessments (e.g., scored), learning assessments (e.g., knowledge, understanding, further materials/training, discussion, and so on), other assessments that may be desirable, or some combination thereof. A resulting assessment may additionally be conducted in a distributed or localized manner, or locally or remotely in whole or part or some combination.

It will become apparent that system 100a may more generally provide for generating assessment item portions or further facilitating assessment or assessment utilization of a person or persons, entities or entity portions, and so on, or may also be applicable to assessment of other living organisms, any one or more of which may comprise a student or student group. A student or student group may also include expert systems, AI systems, other processing systems, other devices, and so on, or some combination. For example, assessment item portions determined by system 100a may include one or more test program portions for assessing a device, firmware, operation thereof, and so on, or some combination, according to device criteria, criteria pertaining to humans or other living organisms, or some combination.

For clarity sake, however, human students or student groups will be used to provide a consistent student example according to which the invention may be better understood. A more specific assessment example of separately administered testing will also be used as a consistent example according to which testing or other assessment embodiments of the invention may be better understood. Various other embodiments will also become apparent to those skilled in the art in accordance with the discussion herein.

Note that the term “or” as used herein is intended to include “and/or” unless otherwise indicated or unless the context clearly dictates otherwise. The term “portion” as used herein is further intended to include “in whole or contiguous or non-contiguous part” which part can include zero or more portion members, unless otherwise indicated or unless the context clearly dictates otherwise. The term “multiple” as used herein is intended to include “two or more” unless otherwise indicated or the context clearly indicates otherwise. The term “multimedia” as used herein may include one or more media types unless otherwise indicated or the context clearly indicates otherwise. It will also be appreciated that the term “learning map” may also refer to a learning map portion unless otherwise indicated or the context clearly indicates otherwise.

In a more specific embodiment, system 100a provides for receiving a targeted skill or targeted skill determining criteria from which a targeted skill may be determined. Such criteria may, for example, include student/group, subject, level, goal, assessment standard or other assessment specification, syllabus, learning materials, and so on, or some combination. System 100a also provides for determining therefrom a targeted skill and any related skills, and for determining one or more patterned response or other assessment item (hereinafter, item) types corresponding to one or more, and typically all, of the determined skills. In other embodiments, system 100a may provide for determining one or more item portions that may correspond to more specific criteria, such as depth of knowledge, prior/future assessment, time to learn, time since learning/assessment, likelihood of forgetting, aggregation, and so on (e.g., of a particular skill or skill set at some granularity).

A patterned response item in one embodiment includes an item that may be generated from criteria sets (hereinafter, “item patterns” or “item renditions”) that may be associated with and form assessable expressions of particular corresponding skills. A skill may, for example, include but is not limited to a teachable concept (TC) or a particular learning target (LT) that may be demonstrated in written, performance (action) or other form that may be observed or otherwise assessed, or some combination, at least one level of granularity. (One skill may also be associated with different criteria sets that may be selectable, modifiable, or otherwise determinable in whole or part, and more than one skill is typically assessed in accordance with a particular resulting item. A skill may also correspond with more than one LT or TC or some combination in accordance with the requirements of a particular implementation.)

In one embodiment, the criteria set (hereinafter, “item pattern”) may include but is not limited to criteria corresponding to a stimulus, response, presentation, and response evaluation criteria associated with a particular skill. Stimulus criteria may, for example, be used to determine a stimulus, including but not limited to: a question; statement; student, assessor or assessor confidant instruction; and so on, objects of these; or some combination. Response criteria may further be used to determine one or more of selectable response alternatives (selected responses), constrained constructed responses, student interactions or other actions, or other targeted or otherwise expectable, typically responsive, student actions. (It will become apparent that student responses to a resulting assessment may include expected responses or unexpected responses, the inclusion, exclusion or content of which may be assessed.) Presentation criteria may, for example, be used to determine whether or not stimulus or response portions may be explicitly or implicitly presented to a student/student group, the form or manner of presentation to the student, student group or others, and so on, or some combination. Response evaluation criteria may include one or more response evaluators that may be applied to a response to produce one or more scores (e.g., if student selects only “5” as the correct response then give the student 1 point, otherwise, give 0 points.) Other criteria or some combination may also be used.

An item may, in one embodiment, be formed according to an aggregation of such criteria corresponding to a targeted skill and any related skills. Related skills may, for example, be determined according to a learning order (e.g., provided by reference to a corresponding portion of a probabilistic learning map), other criteria or some combination. One or more of the item pattern criteria may further include dynamic content.

Dynamic content in one embodiment may include one or more of variables or determinable letters, text, numbers, lines, at least partially blank or filled regions, symbols, images, clips or otherwise determinable multimedia portions. In other embodiments, dynamic content may include various characteristics of assessable student actions or other “response(s)” which characteristics may be altered, replaced, refined, used directly or otherwise “modified” in accordance with item pattern, student/student-group, current/prior assessment, curricula information, teaching materials, assessment specification information or other criteria.

More specific examples of dynamic content may include but are not limited to “A” and “B” in the expression “A+B=5”; particular or all proper nouns in a phrase, verbs or other word types in a sentence,

```
e.g., <<name1>> and <<name2>> each have <<numberword>>
  <<thing1>>. If <<name1>> gives <<name2>>
  <<numberword>> of <<pronoun(name2)>>
  <<thing1>>, how many <<thing1>> will <<name2>> have?
```

from which the following or other item portions may be produced
John and Bill each have three apples. If John gives Bill all of his apples, how many apples will Bill have?;
   specific terminology presented in an item or expected in a student response,
e.g., “pine tree” in the sentence “A pine tree reproduces by what mechanism?” may be represented as “A <<plant which reproduces using seeds>> reproduces by what mechanism?”
   and so on. Dynamic content may further be of a type that may be resolved individually (hereinafter, individual dynamic content or “IDC”),
e.g., “John” and “Bill”, “apple”, and “three” in the expression “John and Bill each have three apples. If John gives Bill all of his apples, how many apples will Bill have?”
   or in combination with other dynamic content, typically in a same expression (hereinafter, mutually dependent dynamic content or “MDDC”). For example, “A” and “B” in the expression “A+B=5” may be resolved in view of one another and are mutually dependent).

While capable of operating in a substantially programmatic or otherwise automatic manner (hereinafter, automatically), system 100a is also operable in conjunction with user intervention. In one embodiment, for example, system 100a may be incapable of generating a complete item corresponding to all applicable item generation criteria (e.g., item pattern, processing time or other criteria). System 100a in one embodiment is configurable in such cases for relaxing such criteria in a manner that may limit precise assessment of an item (e.g., where an assessment of a response may be attributable to more than one student skill deficiency or other characteristic) or may fail to produce a sufficiently complete assessment item (e.g., producing fewer than desirable presented or not-presented student response alternatives). System 100a is further configurable in such cases for storing corresponding documentation information or alerting a subject matter expert (SME) or other user(s) that intervention may be desirable. System 100a is also operable for receiving from such user(s) criteria, item portions or other information that may be utilized in further system 100a operation (e.g., see above).

In the more specific embodiment of FIG. 1a, an assessment generation system 113 of an assessment provider system 101 provides for generating assessment items portions (hereinafter, test items), or further, for generating one or more assessments (testing materials) that may include all or some of the generated test items. Assessment generation system 113 may further provide for generating more than one version of the testing materials, for example, corresponding to one or more particular students or student groups (e.g., personalized, ethnically or otherwise demographically refined, according to subject, level, depth of knowledge, assessment, syllabus, learning materials, student/group experience or control/assessment-evaluation criteria, and so on, or some combination, for example, as is discussed in greater detail below). A resulting assessment may, for example, include one or more paper or other hard copy assessment materials (hereinafter, “testing materials”) within which the assessment is embodied. Available testing materials may then be delivered to one or more test sites 102, 102a in an otherwise conventional or other manner.

Student assessing using the testing materials (hereinafter, “student testing”) may be administered at one or more locations 122a, 122b within test site 102 (or 102a) to one or more students, which are not shown. Testing may be administered in an otherwise conventional manner at various locations 122a, 122b within each test site 102, 102a using the received testing materials 121. Testing materials including student responses (hereinafter collectively referred to as “student answer sheets” regardless of the type actually used) may then be collected. Other testing materials provided to students, officiators or both including but not limited to test booklets, scratch paper, audio/video tape, images, and so on, or some combination, may also be collected, for example, in an associated manner with a corresponding student answer sheet (if any), and may also be assessed. (In another embodiment, a more observational assessment including observable criteria item portions may be delivered including assessment items to be presented to officiators, students or both. Combined assessment types may also be provided.)

Any testing materials may then be collected and delivered to a subject assessment system, if different, e.g., system 111 of assessment provider system 101, for scoring, evaluation or other assessment. (It will be appreciated that more than one assessment provider system of one or more assessment providers may also conduct assessment of the testing materials.)

Assessment generation system 113 may further provide, to a subject assessment system, assessment facilitating parameters for facilitating assessment of items or portions thereof that were produced or producible by assessment generation system 113. Assessment facilitating parameters or “response evaluation criteria” may, for example, include criteria for selecting diagnostic information (e.g., one or more learning map portions) corresponding to item portion generation or other operational constraints.

In a further embodiment, assessment generation system 113 may also receive from a subject assessment system (e.g., 111) one or more of sample or actual assessment results, analyses thereof, diagnostic information (e.g., one or more learning map portions), and so on, or some combination, and utilize such results (e.g., in a recursive manner) as criteria for refining or otherwise generating current or future assessment items or item patterns. For example, results/analyses may be used to verify or validate item portions or expected results. Stray marks or student responses may, for example, indicate apparent student or student group understanding or misunderstanding, an over or under abundance of correct, less correct, less incorrect or incorrect responses may be undesirable, a distribution of demonstrated skills may suggest refinement, and so on. Cluster analysis or other techniques may also be used to identify or analyze expected or unexpected results, to identify trends, demonstrated skills, item or other assessment portion efficiency/inefficiency, common errors, and so on. Some combination of mechanisms may also be used by a subject assessment or assessment generation system or both, and identified characteristics or other criteria may be incorporated into further item portion generation (e.g., refinement), assessment verification/validation, and so on by one or more of such systems.

Assessment generation system 113 in one embodiment includes item generation engine 116 and item/assessment producing device 114 (e.g., printer, audio/video renderer, and so on, or some combination). Assessment generation system 113 may be further coupled, e.g., via a local area network (LAN) or other network 112, to a server 115 and to subject assessment system 111. Assessment generation system 113 is also coupled (via network 112) to subject assessment system 111 and item response receiving device 110 (e.g., a scanner, renderer, other data entry device or means, or some combination).

In another embodiment, item generation engine 116 of assessment generation system 113 or other system 101 components or some combination may be operable in a stand-alone manner or otherwise via local or remote access. (See, for example, FIG. 4)

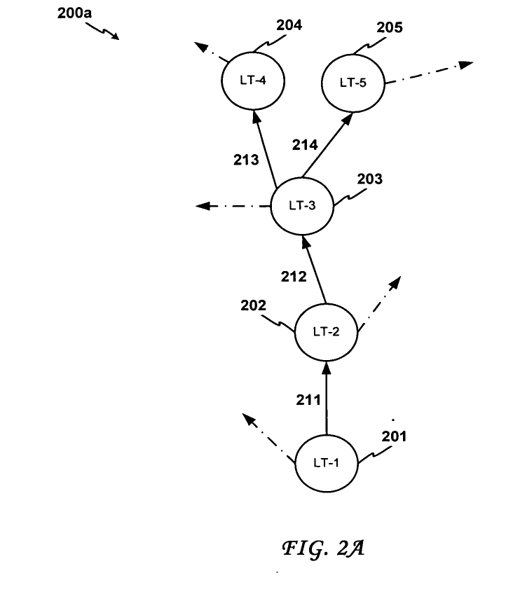

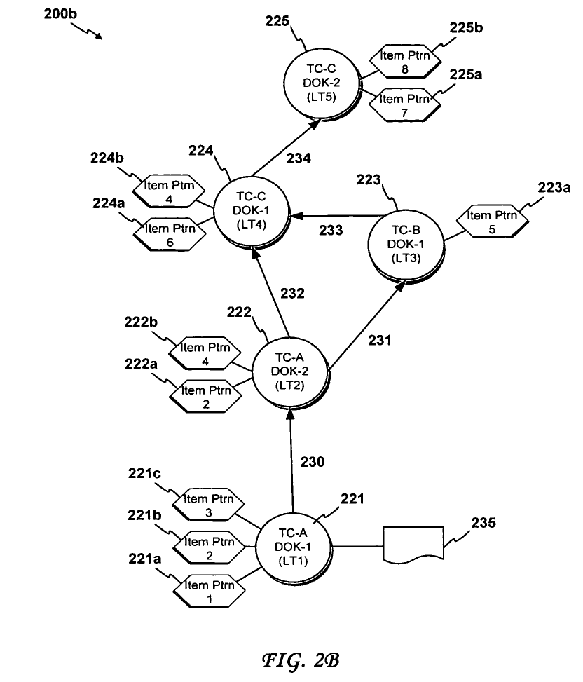

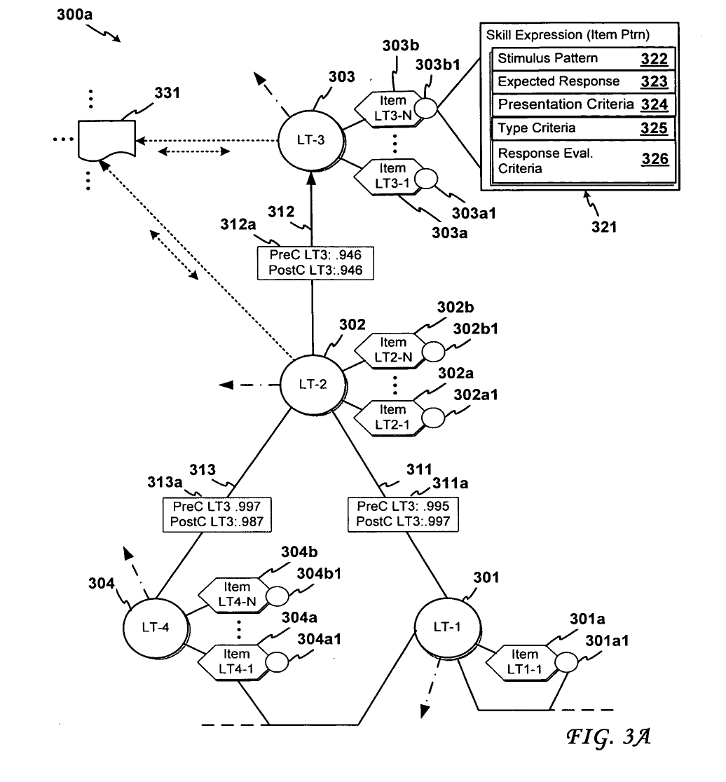

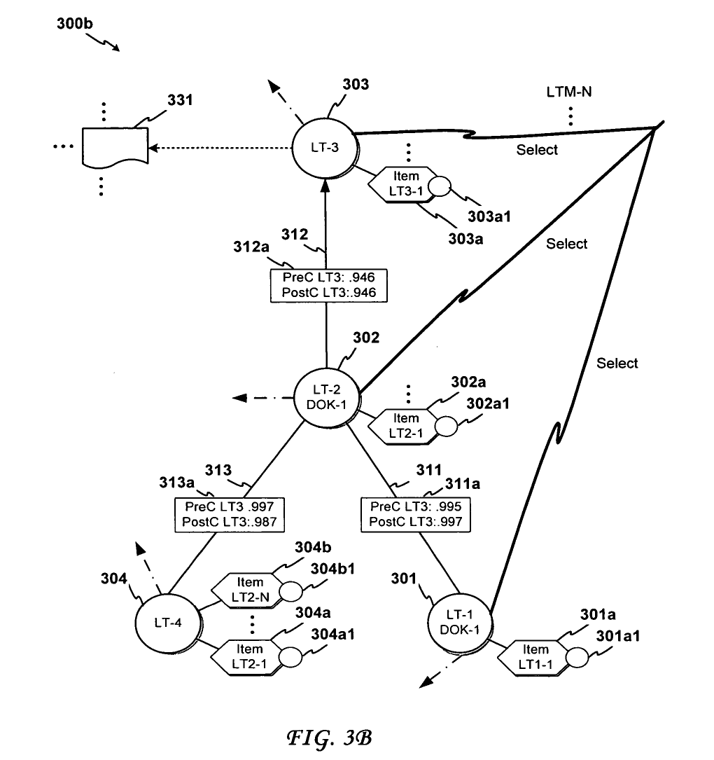

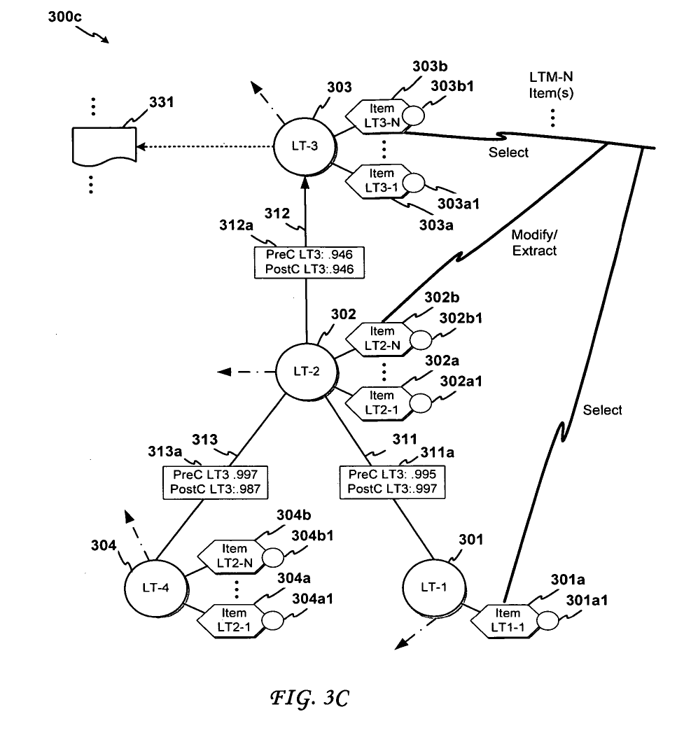

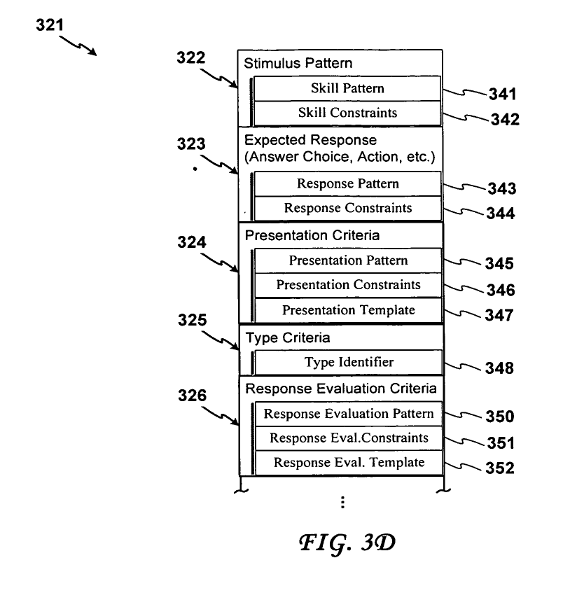

Item generation engine 116 includes learning map 116a, skill/item pattern determining engine 116b and content determining engine 116c. Examples of suitable learning maps are illustrated by FIGS. 2a through 3a.

Beginning with FIG. 2a, learning map 200a includes a set of nodes 201-205 representing learning targets LT1-LT5, respectively. Learning map 200a also includes arcs 211-214, which illustrate learning target postcursor/precursor relationships. The dashed arcs represent that learning map 200a may comprise a portion of a larger map. In more specific embodiments, learning maps may include directed, acyclic graphs. In other words, learning map arcs may be uni-directional and a map may include no cyclic paths. Examples of learning maps and methods of developing them and using them to guide assessment, learning interaction, learning materials and other aspects of learning are described in U.S. patent application Ser. No. 10/777,212, corresponding to application publication no. US 2004-0202987, the contents of which are hereby incorporated by reference.

In the learning map embodiment 200b of FIG. 2b, each learning target LT1-LT5 (nodes 221-225) represents or is associated with a smallest targeted or teachable concept (“TC”) at a defined level of expertise or depth of knowledge (“DOK”). A TC may include a concept, knowledge state, proposition, conceptual relationship, definition, process, procedure, cognitive state, content, function, anything anyone can do or know, or some combination. A DOK may indicate a degree or range of degrees of progress in a continuum over which something increases in cognitive demand, complexity, difficulty, novelty, distance of transfer of learning, or any other concepts relating to a progression along a novice-expert continuum, or any combination of these.

For example, node 221 of learning map portion 200b includes a learning target (LT1) 221 that corresponds with a particular TC (i.e., TC-A) at a particular depth of knowledge (i.e., DOK-1). Node 222 includes another learning target (LT2) that represents the same TC as learning target LT1 (node 221), but at a different depth of knowledge. That is, learning target LT2 of node 222 corresponds to TC-A at a depth of knowledge of DOK-2. Using DOKs, for example, it is found that different progressions of learning or “learning paths”, e.g., through learning map nodes, may be discovered or indicated (hereinafter, “mapped”). Similarly, nodes 224 and 225 represent learning targets LT4 and LT5 with the same teachable concept TC-C but at different depths of knowledge, DOK-1 and DOK-2. Node 223 represents another learning target with a distinct teachable concept TC-B at a beginning depth of knowledge (DOK-1).

Arc 230, which connects nodes 221 and 222 (LT-1 and LT-2), represents the relationship between the learning targets LT1 and LT2 that correspond respectively to nodes 221 and 222. Because arc 230 points from node 221 to target 222, target 221 is a precursor to target 222 and target 222 is a postcursor of target 221.

Similarly, arc 231 extends from node 222 to node 223 and represents that the learning target LT2 represented by node 222 is a precursor of the learning target LT3 represented by noted 223 (and conversely, node 223 is a postcursor of node 222). Arc 232 represents that the learning target LT2 represented by node 222 is also a precursor of the learning target LT4 represented by noted 224 (and conversely, node 224 is a postcursor of node 222). This indicates that proficiency with respect to the learning targets of either of nodes 223 or 224 implies a precursor proficiency with respect to the learning target of node 222.

Arc 233 represents that the learning target LT3 represented by node 223 is a pre-cursor of the learning target LT4 represented by node 224 (and conversely, node 224 is also a post-cursor of node 223). This indicates that progression toward proficiency with respect to the learning target of node 224 can progress through node 222 or node 223. It similarly indicates that proficiency with respect to the learning target of node 224 implies pre-cursor proficiency with respect to the learning targets of both nodes 222 and 223.

Finally, arc 234 represents that the learning target LT4 represented by node 224 is a pre-cursor of the learning target LT5 represented by node 225 (and conversely, node 225 is a post-cursor of node 224).

In the learning map shown in FIG. 2b, each learning target LT1-LT5 (nodes 221-225) is associated (“linked”) with a set of one or more assessment items or assessment item patterns. Item patterns 221a, 221b, 221c are linked to the learning target LT1 of node 221, item patterns 222a, 222b are linked to the learning target LT2 of node 222, item pattern 223a is linked to the learning target LT3 of node 223, item patterns 224a, 224b are linked to the learning target LT4 of node 224, and item patterns 225a, 225b are linked to the learning target LT5 of node 225. As also shown in FIG. 2b, a particular item pattern may be linked with more than one learning target. For example, learning target LT1 (node 221) is linked with three item patterns, item patterns 1-3 (221a, 221b, 221c), and learning target LT2 (node 222) is linked with item pattern 2 and item pattern 4 (222a, 222b). Similarly, both learning target LT2 (node 222) and learning target LT4 (node 224) are linked to item pattern 4 222b, 224b (which item pattern or portion thereof may be repeated or linked via more than one association, here to corresponding nodes of one or more learning maps or portions thereof).

Preferably, a learning target is only linked with items or item patterns that target the learning target. In other words, preferably, a learning target is linked with only those items that are useful in assessing whether or to what extent it may be concluded that a learner knows the learning target.

In a more specific embodiment, precursor and postcursor probability values are associated with skill (learning target) nodes that may be used to determine whether assessment should be conducted respecting related skills, and if so, the manner of presenting the skill in conjunction with one or more item portions. For example, a postcursor relationship may indicate a probability that learning (i.e., or knowledge) of a postcursor skill may indicate learning of a pre-cursor skill, whereby assessment of the precursor skill may not be needed for more complete assessment. Therefore, assuming that no other criteria indicates that the precursor skill should be explicitly assessed, an assessment portion generator, e.g., item generating engine 116 of FIG. 1a or FIG. 1b, may (automatically) determine that explicit assessment of the precursor related skill may be excluded from an item portion or assessment if the corresponding postcursor skill is assessed. Conversely, a lack of learning (or knowledge) of a precursor skill may indicate a probability of a lack of learning of a postcursor skill, whereby assessment of one or more of the pre-cursor skills or further down the precursor path or paths defined by the learning target relationships may be needed for more complete assessment. Therefore, assuming that no other criteria indicates that assessment of the precursor skill should not be explicitly assessed (i.e., or that such assessment should be avoided), item generating engine 116 may (automatically) determine that explicit assessment of the precursor related skill may be included in an item portion or assessment. (It will become apparent that an assessment processing, learning materials, static/interactive hardcopy or electronic education or other learning or knowledge system, including but not limited to a patterned response system, may conduct one or more portions of the above or other processing discussed herein, and may do so automatically or with user intervention.)

In learning maps embodiments including depth-of-knowledge (DOK) or other criteria, such criteria may also be considered in conducting the above (automatic or user-verified/validated or otherwise user-assisted) determination. For example, learning maps including integrated DOK (e.g., corresponding to each node) provide a more straight forward approach whereby only those skills, e.g., nodes, having a corresponding DOK may be considered unless uncompleted path or other considerations otherwise require. Such implementations therefore enable a path of related skills (e.g., teaching/learning path) to be readily determined by an assessment portion generator (or person). Related skills may be determined at the same, different or more than one DOK, which may, for example, be implemented as suitable criteria, in accordance with the requirements of a particular implementation.

(It will be appreciated that an explicit indication of above, other criteria or some combination may also be received and processed by engine 116.)

Other criteria for including or excluding skills may, for example, include assessing a student's or student group's ability to recognize or apply a skill provided to the student in the form of a presented item portion. For example assessing the ability or inability of the student to perform a skill may be instructionally useful, or useful for some other decision making process, such as advancement decisions, financing decisions, legislative decisions or other decisions which are intended to be supported by the assessment, to avoid assessing or intentionally assess infirmity (e.g. visual or hearing impairment; physical impairment such as paralysis or weakness or fine or gross motor control deficiency; dyslexia; attention deficit disorder; color blindness, and so on), to accommodate for or determine learning style (e.g. visual learner, kinesthetic learner, auditory learner, and so on), to fill out a required number of items that address particular skills in an item bank, or to ensure that there are sufficient items addressing commonly assessed skills, to enable limiting the number of times a given item or item portion is presented to a given population of students or to constrain the presentation of an item or item portion to no more than a given number of times to a specific student. Other criteria or some combination of criteria may also be used.

The present embodiment, however, provides for a determination of pre/post cursor or otherwise related skills for inclusion or exclusion in a current, prior or later item portion or a current or later assessment to extend beyond immediate pre/post cursor skills (e.g., that may be directly coupled in a learning map). For example, skill/pattern determination engine 116b of FIG. 1 may determine inclusion/exclusion or presentation of lesser related skills according to an aggregation of pre/post cursor values. In one embodiment, a student's prior learning map report (which provides information including the likelihood of a student having a certain skill) may be used to provide previous performance information for the student. This information may be used in conjunction with normative predicted progress of the student through a learning map (which may or not be modified based on individual student parameters) and time since prior performance was demonstrated, as factors in determining a set of skills that should be included in an assessment. Using the learning map embodiment of FIG. 2b for example, skill/pattern determination engine 116b may refer to a learning map report for a student which provides the information that a student has demonstrated knowledge in LT1 221 and LT2 222, but not in LT3, LT4 or LT5 (223-225). Details concerning the evaluation and use of learning map data can be found in commonly-assigned U.S. patent application Ser. No. 11/135,664, the disclosure of which is hereby incorporated by reference. Incorporating information from the learning map report and norm referenced information on time-to-knowledge or time-to-learn and time-to-forget, and the Learning Map Precursor/Postcursor Probability Relationships 116a as well as the time passed since the students' performance was last assessed, skill/pattern determination engine 116b may determine that the assessment for the student should include items targeting LT3-LT5 as well as LT2. Once skill/pattern determination engine 116b has determined the learning target(s) to assess, Item Generation engine 116 may generate item patterns and items associated with the determined learning targets. (See, for example, FIGS. 2b and 3a). Other mechanisms or some combination may also be used.

Learning map portion 200b of FIG. 2b also provides for storing more than one item pattern (or resolved item pattern) corresponding to each node. In the case of item patterns, such multiplicity provides for storing item patterns that may correspond to different item types, different aspects of a skill, different multimedia, presentation type, device, mode (e.g., grouping presented, interactive or not, and the like) or other presentation criteria, and so on, or some combination. It is not, however, necessary for all item pattern permutations or items to be represented at each node. Rather, portion 200b may store criteria for determining conversion, extraction or other modification mechanisms for sufficiently generating a suitable item pattern for use as a target or related item pattern. (Alerting, documenting or otherwise indicating a gap or that a (more) suitable item pattern may require system or user intervention may also be implemented in accordance with the requirements of a particular implementation.)

Such modification may, for example, include more direct modification, such as pattern portion extraction and conversion (e.g., replacing “twenty-two” with “22” to correspond with a numerically presentable resulting item), determining demographically or otherwise group-suitable colors, names, audio/video characteristics, and so on (e.g., replacing “Bob” with “Jose”, replacing the picture of the 10-12 year old African child with a 15-17 year old Mexican child, changing the voice frequency from a male to a female voice, changing the setting of the images from deserts to forests, and so on), assessment-suitable modifications (e.g., length, consistency/variation, assessment specification criteria, and so on), and so on, or some combination. See, for example, the embodiments of FIGS. 3b and 8 through 9.

Learning maps 200b through 300b (FIGS. 2b and 3b) also illustrate how learning documents may be producible or useable as corresponding learning map objects or criteria. In FIG. 2b, for example, one or more learning documents/learning document patterns 235 may be associated with or generated in conjunction with one or more learning map nodes. Associating the learning document/learning document pattern 235 with node 221, for example, may provide directly (or via transfer) for review by a student, student being assessed (e.g., open book), teacher, assessor, and so on in conjunction with learning or assessment. Other nodes may similarly provide for reviewably storing corresponding learning materials, or further, for providing an ordering of review according to pre/post cursor relationship, other criteria or some combination. Node 221 may also be modified (e.g., providing one or more items or item patterns) in accordance with such learning document/learning document patterns 235, among other combinable mechanisms.

Learning map 300a of FIG. 3a more clearly illustrates a more specific instance in which learning materials 331 may be similarly stored or utilized in conjunction with more than one node (e.g. 302 and 303). For example, portions of one or more of textbooks, guides, brochures, articles, assessments, examples, electronic learning, URL, other multimedia “documents”, and so on may be provided in accordance with the structure or operation of a learning map, or may be generated from a learning map.

Learning maps 300a, 300b, 300c shown in FIGS. 3a, 3b, 3c, respectively, include learning targets LT-1 through LT-4 (nodes 301-304). Items or item patterns may be associated (linked) with each learning target node. That is, item LT1-1 (301a) is linked to node LT-1 (301), items LT2-1 to LT2-N (302a-302b) are linked to node LT-2 (302), items LT3-1 and LT3-N (303a-303b) are linked to node LT-3 (303) and items LT4-1 to LT4-N (304a-304b) are linked to node LT-4 (304). Item pattern 301a1 is also linked to node LT-1 (301) and may further be associated with item LT1-1 (301a). Item patterns 302a1 and 302b1 are linked to node LT-2 (302) and may also be associated with items LT2-1 (302a) and LT2-N (302b) respectively. Similarly, item patterns 303a1 and 303b1 are linked to LT-3 (303) and may also be associated with items LT3-1 (303a) and LT3-N (303b), and item patterns 304a1 and 304b1 are linked to LT-4 (304) and may also be associated with items LT4-1 (304a) and LT4-N (304b) respectively.

As was noted earlier, the illustrated items may also be associated with more than one node. For example, item LT4-1 (304a) is associated with both nodes LT-1 (301) and LT-4 (304). Item LT4-1 may also comprise a portion of an associate-able pool of items that is available for association with various nodes in conjunction with assessment portion generation, interactive or other learning, gaming, generating other learning materials or other purposes (e.g., see above), or other mechanisms or some combination may also be used.

Similarly, an item pattern may be associated with more than one node or more than one item. In one embodiment, for example, item pattern 304a1 may be associate-able with node LT1 (301) or LT4 (304) for use in generating (i.e., or modifying) items corresponding to nodes LT1 or LT4 for assessment or other purposes. Item pattern 304a1 may also may be associated with a pool of item patterns that is available to nodes LT1 or LT4 for generating items for assessment or other purposes, or other mechanisms or some combination may also be used. Item pattern 304a1 may also, in another embodiment, be associated with items generated using item pattern 304a1, such as item LT1-1 (301a) or item LT4-1 (304a). Thus, among other uses, an item may be traced back to a corresponding source item pattern for modification, verification, validation or other purposes. Another embodiment provides for associating an assessment, scoring report, learning document, or other learning tool(s) with a corresponding item or item pattern for enabling further generating, tracing or other flexibility, while still further embodiments provide for utilizing various combinations of the above or other association, pooling or other mechanisms. Such mechanisms may, for example, in various embodiments consistent with systems 100a or 100b of FIGS. 1a and 1b, be conducted by assessment generation system 113, subject assessment system 111 or other suitable components in an otherwise conventional manner for forming, utilizing or modifying associations.

Arc 311 indicates a pre-cursor/post-cursor relationship between learning target node 301 and learning target node 302. Similarly, arc 312 indicates a pre-cursor/postcursor relationship between learning target node 302 and learning target node 303, and arc 313 indicates a precursor/postcursor relationship between learning target node 302 and learning target node 304. Block 311a illustrates exemplary probabilistic precursor and postcursor relationships (0.995 and 0.997 respectively) for arc 311, block 312a illustrates exemplary probabilistic precursor and postcursor relationships (0.946 and 0.946 respectively) for arc 312, and block 313a illustrates exemplary probabilistic precursor and postcursor relationships (0.997 and 0.987 respectively) for arc 313. Thus, for example, if learning target LT1 represented the skill of addition of two single digit numbers where the sum of the digits is less than ten, and learning target LT2 represents the skill of addition of two single digit numbers where the sum of the numbers is greater than 10, the probability of knowing LT1 if the skill of LT2 is demonstrated would be 0.997. Similarly, the probability of not knowing LT2, if LT1 is not known would be 0.995.

It will become apparent in view of the discussion herein that other learning map implementations, or some combination may also be used in accordance with the requirements of a particular implementation.

Continuing now with FIG. 1a, item generation engine 116 also includes skill/pattern determination engine 116b and content determination engine 116c. Skill/pattern determination engine (pattern engine) 116b provides for determining, from received criteria, a target skill and related skills, an expression of which may be included in a resulting item or items, and for determining corresponding item pattern information.

As was noted above, received criteria may include an explicit expression of the target skill and one or more of the related skills, or further, a depth of knowledge (DOK), or other criteria from which such skills may be determined. An assessment specification of a testing authority, learning institution, employer, and so on may, for example, provide criteria such as a syllabus, job description, textbook or other multimedia presentation requisites, assessment schedule, and so on. Such criteria may further include student goals, responsibilities and so on corresponding to one or more particular subjects, topics and one or more corresponding learning/performance (“grade”) levels. Alternatively or in conjunction therewith, mechanisms such as parsing/indexing, frequency distribution, artificial intelligence (AI) or other processing may also be used to determine, from available information, one or more target skills that may be used as a basis for one or more corresponding items. One or more of prior performance, future assessment, assessment accumulation, education/industry information or other materials, student/group specific or generalized learning maps or SME or other user input, other mechanisms or some combination of mechanisms may also be used to provide criteria for selecting one or more learning targets in accordance with the requirements of a particular implementation.

In one embodiment, pattern engine 116b selects a learning map node relating to a skill that corresponds to the learning target criteria. Pattern engine 116b further utilizes learning map 116a, or further selection criteria such as that already discussed to determine related skills. Turning also to FIG. 3b, given a target skill corresponding to LT-2 302 (e.g., addition with no regrouping), pattern engine 116b may, for example, select related skills as corresponding to nodes according to the pre/post cursor and DOK relationship of such nodes with a target node, or further, as corresponding to further selection criteria. A closest and then increasing pre/post cursor relationship may, for example, be used to exclude those nodes that correspond to a predetermined or otherwise determinable certainty that such nodes do not require assessing in conjunction with a particular assessment or assessment portion. Further selection criteria may, for example, include selection of highest inferential nodes (e.g., pick 5% of the nodes that are most related or have the highest probability of being related to the other 95% of the nodes) or select enough nodes such that the reliability of an assessment of the nodes would attain a desired degree of validity (e.g., select nodes such that 95% of the students would be measured with a standard error of measurement of no more than 5%), and so on, or some combination.

The number of related nodes selected by pattern engine 116b may, for example, be predetermined or otherwise determinable as providing a sufficient sampling for creating a requisite or otherwise desirable number of presented or not-presented expectable student responses, e.g., corresponding to assessment specification criteria. (Criteria may, for example, include “the assessment will have selected response items with 5 answer choices, 1 correct and 4 incorrect”). However, the number (or selection or other aspects) of selected related nodes may be decreased (or otherwise modified) through further item portion generation operations. Therefore, assuming that each presented or not presented item response (e.g., for the item “4+3=?”, expected responses may include the correct response “7”, incorrect responses “1”, “12”, “43”, “3” and “4”), will correspond to a different related skill (e.g. for the item “4+3=?”, the answer “1” corresponds to the skill of subtraction rather than addition). Note that sufficient sampling will often include a greater number of skills than a target number of resultant item responses. A determinable number of related skills may, for example, be determined according to prior selection experience, e.g., given by a learning map or other criteria, and may be fixed or variable according to the requirements of a particular implementation.

Pattern engine 116b further provides for determining item patterns corresponding to determined skills that may be used to further determine a resultant item. In a more specific embodiment, pattern engine 116b determines initial or target item patterns corresponding to a determined target skill and related skills, and forms from the target item pattern an aggregate item pattern that it then attempts to resolve.

FIG. 3a, for example, illustrates that different item patterns (e.g., item pattern LT3-N 303b) may be of different types, and thereby capable of providing criteria according to which pattern engine 116b (FIG. 1a) may generate items of one or more corresponding types. Pattern engine 116b further provides for modifying item criteria, for example, to utilize item pattern criteria for one item type in conjunction with item pattern criteria of a different type. Using such a mechanism, pattern engine 116b enables the use of a learning map in which complete pattern redundancy is not required. Stated alternatively, an item pattern type corresponding to a target node need not be available corresponding to a second node in order to form an item utilizing the corresponding skills. Thus, for example, a newly added item pattern need not be distributed to all nodes in a learning map portion before the learning map portion may be used to generate an item.

Operationally, pattern engine 116b in one embodiment selects a first item pattern corresponding to a target skill according to a default, e.g., default type, or according to an assessment specification or other criteria (e.g., see above). Pattern engine 116b further attempts to select item patterns of determined related items of a same or similar type. If a suitable type is unavailable, then pattern engine 116b may attempt to extract one or more applicable item pattern portions or otherwise modify the selected or related item pattern as needed. If pattern engine 116b is unable to select or modify a corresponding item pattern, then in various embodiments pattern engine 116b may alert an SME or other user, disregard or further document that it is disregarding the item pattern or corresponding skill, and so on, or some combination. (See also FIG. 3c.) An SME may provide the item pattern information to pattern engine 116b for further processing, e.g., responsive to such an alert or otherwise.

Pattern engine 116b further provides for determining whether all item pattern criteria of all item patterns may be met, and removing excessive related item responses in excess of a target number of expected responses, or providing for SME or other user intervention if a sufficient number of expected responses may not be determined. In one embodiment, excessive responses, or further, other item criteria corresponding to a removed related item response, may also be removed in an order of from least related to more related using pre/post cursor values of learning map 116a, thereby producing an intermediate item. Other removal criteria may also be utilized or some combination thereof in accordance with the requirements of a particular implementation.

As shown in FIG. 3a, each item pattern 321 of learning map 300a includes a stimulus pattern 322, an expected response pattern 323, presentation criteria 324, type criteria 325, and response evaluation criteria 326, one or more of which may include null, fixed, random or dynamic criteria, e.g., as was already discussed. Stimulus pattern 322 provides for resolving the item pattern to provide a stimulus. A stimulus may, for example, include a question, statement, initiating instruction, incentive, one or more objects or other impulse, if any, for initiating an assessable student responsive action or for initiating observation of a student to determine an assessable (e.g., observable) student action. Alternatively stated, a stimulus may include substantially any initiating occurrence that may result in a measurable assessment of a student response. (Objects may, for example, include a list of things to be placed in order, corrected, defined, annotated or otherwise manipulated or used in providing a student response, e.g., a list of words following a question portion of a stimulus such as “Which of the following words has two syllables?”)

Expected response criteria 323 provides for resolving an item pattern to provide one or more expected responses. An expected response may, for example, include an expected student answer, action or other response or a baseline expected response to which a student response may be compared (i.e., or contrasted) or otherwise analyzed and assessed. Stated alternatively, a student response may include any student thought or action for which a corresponding measurable assessment may be produced.

Presentation criteria 324 provides for resolving an item pattern to provide a manner of presenting, partially presenting (i.e., or partially not presenting) or not presenting a corresponding stimulus or response portion, an item portion or some combination thereof. For example, presentation criteria might specify not presenting any of the expected responses, but instead providing an answer area, e.g. “4+3=______”, or it may specify presenting or not presenting labeling for an axis on a graph. Presentation criteria may also, for example, specify conditional criteria for accommodation of students, such as enabling or disabling text readers for an item for specific or all students or groups thereof in a population by selection criteria, e.g., “all visually impaired students”.

Any stimulus or response portion in a resulting item that is determined to be presented to a student (or others) in conducting an assessment will also be referred to as a presented interaction item portion (“PIP”). Any stimulus or response portion in a resulting item that is determined not to be presented to a student (or others) in conducting an assessment will also be referred to as a not-presented interaction item portion (“NPIP”).

It should be noted that the nature of stimulus or response portions may vary considerably in accordance with an item (pattern) type, assessment (or other use), student/group, assessing or other authority and so on, or some combination. For example, a stimulus or response (e.g., depending on the particular implementation) may include one or more of letters, numbers, symbols, audio, video or other multimedia that may further include one or more dynamic content portions. A stimulus or response may also include a wide variety of objects that may also include one or more dynamic content portions. For example, a selected response item may or may not include static or dynamic objects that may be useable in formulating a student response. A graphing response item may, for example, include a presented or not presented graph structure, labeling response parameters (e.g., length, slope, start/end point, curve, included labeling, response region or response or evaluation sub/super region, and so on). Audio/video producing, editing or other items may, for example, include other multimedia content or define presented or not presented parameters for assessing a student response (that may, for example, be provided to an assessment system for facilitating assessing of correct, incorrect or more or less correct responses or response portions relating to one or more skills). Observational assessing items (or other items) may or may not provide a more conventionally oriented student or assessor stimulus or response (e.g., initiating or guiding a response or merely initiating observation, recording, evaluation, etc.), and so on. The terminology used here and elsewhere is intended to facilitate an understanding by attempting to provide more conventional-like terminology and is not intended to be limiting.

FIG. 3d, for example, illustrates a more detailed embodiment of the of the item pattern example 321 of FIG. 3a. In this embodiment, stimulus pattern 322 includes skill pattern 341 and skill constraints 342, expected response pattern 323 includes response pattern 343 and response constraints 344, presentation criteria 324 includes presentation pattern 345, presentation constraints 346 and presentation template 347, and type criteria 325 includes type identifier 348, response evaluation criteria 326 includes response evaluation pattern 350, response evaluation constraints 351, and response evaluation template 352.

Skill pattern 341 provides a stimulus pattern or framework that may be resolved to form an item stimulus. In a more specific embodiment, only the skill pattern of a target skill is utilized by pattern engine 116b (FIG. 1) for generating an item framework. As will be discussed, however, a skill pattern or skill constraints of one or more related skills may be used by content determination engine 116c (FIG. 1a) for determining criteria according to which skill pattern content may be constrained. Skill patterns may, for example, include but are not limited to those stimulus examples provided with reference to FIG. 3a. More specific skill patterns may, for example, include laws of motion patterns (e.g., “Force=Mass×Acceleration”) for assessment of a physics student having a sufficient DOK in recalling Newton's First Law or applying Newton's First Law, for assessment of a culinary student having an insufficient DOK in mixing cake batters, and so on.

Skill constraints 342 provides for limiting the nature or extent of a skill pattern, which may further define or refine an expected correct or incorrect response (e.g., where correctness assessment is conducted in a more absolute manner), or an expected graduated or separable response having aspects that may be assessed as having correct or incorrect portions or other gradations of correctness or incorrectness. Skill constraints 342 may, for example, include but are not limited to: bounding conditions, objects, and so on for a mathematical equation, selection, de-selection or other markup criteria for a markup or matching item; range, type, number, refinement or other graphing item criteria; edit conditions/points, number of chapters, arrangement, length, timing, start/stop points or other composition, performance or (pre/post) multimedia production item criteria; widget/tool, physical boundaries, demeanor, applicable rules, goal or other job performance item criteria; and so on. A more specific skill constraint example may, for example, include “Force<=10 N”, “Acceleration=Whole Number”.

Response pattern 343 and response constraints 344 respectively provide a response pattern or framework that may be resolved to form an item response in a similar manner as with skill pattern 341 and skill constraints 342. In a more specific embodiment, the response pattern, response constraints or both corresponding to each of a target skill and one or more related skills may be used by pattern engine 116b (FIG. 1) for generating corresponding presented or not presented item response portions. Examples of response patterns may, for example, include but are not limited to “Force=Mass/Acceleration” and examples of response constraints may include but are not limited to “Mass is evenly divisible by Acceleration”.

Presentation pattern 345 provides criteria for determining one or more manners in which one or more resulting item portions may or may not be displayed. Presentation patterns may, for example, include but are not limited to: display/hide [portion_identifier], display/hide [symbol], display/hide [units of measurement] and so on.

Presentation constraint 346 provides criteria for determining one or more manners in which the presentation must be constrained. Presentation constraints may for example include “disallow text readers for the following item for all students”

Which of the following words sounds like through?

A. threw

B. trough

C. though

Presentation template 347 provides criteria for formatting a resulting item in accordance with a corresponding assessment. In one embodiment, a presentation template may be provided as corresponding to each item pattern, while in other embodiments, a presentation template may be provided as corresponding to one or more of a particular item type, assessment type/section, assessment authority specification, and so on, in accordance with the requirements of a particular implementation. Presentation template 347 may, for example, include but is not limited to “Media=Paper font_type=TIMES ROMAN and font_size=9; Media=Screen font_type=ARIAL and font_size=12 for paper presentation”.

Type identifier 348 provides for identifying an item pattern type, for example, as was already discussed.

Response evaluation pattern 350 of response evaluation criteria 326 provides one or more methods for evaluating student responses to derive their meaning. Response evaluation pattern 350 may include, but is not limited to, indication of correct responses, substantially correct responses, substantially incorrect responses or incorrect responses and their corresponding value (numeric, e.g., 2, or categorical, e.g., mastery/non-mastery or other value indicator(s), among other expected response alternatives).

Response evaluation constraints 351 of response evaluation criteria 326 provides constraints on the evaluation of the response (e.g., response must be evaluated by a Spanish speaker.)

Response evaluation template 352 of response evaluation criteria 326 provides methods for configuring the evaluation criteria for the targeted evaluation system or method (e.g., create a PDF for human scoring, convert to XML for AI scoring, and so on, or some combination)

Returning again to FIG. 1a, content determining engine 116c provides for modifying dynamic content in one or more intermediate item portions to conform to one or more particular student/group refinement criteria. Refinement criteria may, for example, include but is not limited to criteria for rendering dynamic content more consistent with one or more of demographic, infirmity or other characteristics of a particular student or student group. For example, the particular proper nouns used in an item for assessing students in one geographic region may be different than those used for assessing students in another region and may be modified by content determining engine 116c to conform to those of a region in which a student group originated or is now located. Wording that may refer to particular things, such as sacred animals, or that may otherwise be more suitably presented in a different manner may also be replaced to conform to student localization. One or more of colors, shapes, objects, images, presented actions or other multimedia portions, their presentation and so on may also be similarly replaced by content determining engine 116c. Such group criteria may, for example, be determined by parsing a sufficiently large collection of localized documents for like terms and identifying as replacements those terms having a sufficiently large recurrence. Other processing mechanisms or some combination may also be used in accordance with the requirements of a particular implementation.

Content determining engine 116c may also provide for modifying dynamic content according to other group characteristics. For example, dynamic content may be modified according to group infirmities, such as dyslexia (e.g., by removing reversible character or object combinations, such as the number “69”), poor vision (e.g., by causing one or more item portions to be presented in a larger size, different font, line thicknesses, colors, and so on), brain trauma, and so on, according to personalization criteria corresponding to a student/group and avoidance criteria corresponding to avoiding problems associated with a particular infirmity. Conversely, content determining engine 116c may also provide for identifying infirmity or other potential learning impacting characteristics by modifying dynamic content to accentuate discovery of such infirmities. Content determining engine 116c may also similarly provide for accommodating, avoiding or assessing other group characteristics, or for personalizing one or more items to a particular student or student group by modifying dynamic content.

Content determining engine 116c may also provide for further refining content to better conform with a knowledge level or other cognitive or physical ability characteristics of a student/group. In this respect, content determining engine 116c may, for example, determine such characteristics from a syllabus, learning map corresponding to a same or corresponding student/group, a learning map produced according to a statistically sufficiently verifiable/validateable estimate, other sources (e.g., see above) or some combination. Content determining engine 116c may further utilize suitable rules or other criteria to modify the vocabulary, grammar, form, multimedia used for a particular purpose, multimedia combination, presentation, requisite action, expected presented or not presented responses, or other item content characteristics to conform to the student/group criteria.

Content determining engine 116c in another embodiment also provides for modifying dynamic content in one or more intermediate item portions to conform to one or more particular assessment refinement criteria. Assessment refinement criteria may, for example, include but is not limited to criteria for rendering an assessment more consistent or variable according to overall DOK, portion length, punctuation style, numbers of digits, multimedia presentation levels (e.g., audio, video, brightness, colors, and the like), and so on. Content determining engine 116c may, for example, conduct such determining by comparing item content according to the assessment refinement criteria, other mechanisms or some combination. Content determining engine 116c also provides in a further embodiment for resolving conflicting user/group and assessment refinement criteria, for example, utilizing suitable weighting, prioritization, range/limit imposition, other mechanisms or some combination, in accordance with the requirements of a particular implementation.

In yet another embodiment, mechanisms including but not limited to the aforementioned presentation template may be used to conform a resulting assessment or assessment items or portions thereof to an assessment or other specification or to modify the presentation of a resulting assessment according to other presentation criteria. Such criteria may, for example, include but is not limited to space utilized, organization, look and feel, and so on, or some combination. Such presentation modification may, for example, be conducted in an otherwise conventional manner for implementing presentation modifications in conjunction with various media creation, (pre/post) production, presentation or other applications.

The FIG. 1b flow diagram illustrates a further patterned response system 100b according to an embodiment of the invention. As shown, system 100b is operable in a similar manner as with system 100a of FIG. 1a. System 100b, however, additionally provides for presenting a resulting assessment or other test materials in electronic, hard-copy, combined or mixed forms, and conducting an assessment or further returning assessment taking results in such forms. System 100b may further provide for performing such assessment and returning assessment taking results from remote user/group sites, among other features.

System 100b includes assessment provider system 101b and test site system 102a1, which systems are at least intermittently communicatingly couplable via network 103. As with system 100a, test materials may be generated by test generation system 113a, including item generation engine 116, in a consistent manner with the embodiments already discussed. A resulting assessment may further be administered in hard-copy form at various locations within one or more test sites 102a1 and the responses or other materials may be delivered, for example, via conventional delivery to performance evaluation system 111a of assessment provider system 101b. In other embodiments, test materials, results or both may be deliverable in hard-copy, electronic, mixed or combined forms respectively via delivery service 104, network 103 or both. (It will be appreciated that administering the assessment may also be conducted with respect to remotely located students, in accordance with the requirements of a particular implementation.)

Substantially any devices that are capable of presenting testing materials and receiving student responses (e.g., devices 124, 125) may be used by students (or officiators) as testing devices for administering an assessment in electronic form. Devices 124, 125 are at least intermittently couplable at test site 102a1 via site network 123 (e.g., a LAN) to test site server computer 126. Network 103 may, for example, include a static or reconfigurable wired/wireless local area network (LAN), wide area network (WAN), such as the Internet, private network, and so on, or some combination. Firewall 118 is illustrative of a wide variety of security mechanisms, such as firewalls, encryption, fire zone, compression, secure connections, and so on, one or more of which may be used in conjunction with various system 100b components. Many such mechanisms are well known in the computer and networking arts and may be utilized in accordance with the requirements of a particular implementation.

As with system 100a, test generation system 113a of assessment provider system 101b includes an item generation engine 116 including at least one learning map 116a, a pattern determining engine 116b, and a content determining engine 116c. In a more specific embodiment, the pattern determining engine 116b is also configured for operating in conjunction with learning map 116a according to a learning relationship that may further be operable according to pre/post cursor learning relationships. Test material producing device 114a may include a printer, brail generator, or other multimedia renderer sufficient for rendering hard copy testing materials. It will be appreciated, however, that no conversion to hard copy form may be required where one or more assessment items, an assessment or other testing materials are provided by the item generation engine in electronic form. Similarly, no conversion to or from hard copy to electronic form (e.g., by scanner 110a or other similar device) may be required for providing assessment-taking results to performance evaluation system 111a where an assessment is conducted and transferred to performance evaluation system 111a in electronic form. Assessment provider system 101b may further include a document/service support system 117a for document support and/or other services. Devices/systems 114a, 113a, 117a, 110a, and 111a of the assessment provider system 101b are at least intermittently couplable via network 112 (e.g., a LAN) to assessment provider server computer 115a.

The FIG. 4 flow diagram illustrates a computing system embodiment that may comprise one or more of the components of FIGS. 1a and 1b. While other alternatives may be utilized or some combination, it will be presumed for clarity sake that components of systems 100a and 100b and elsewhere herein are implemented in hardware, software or some combination by one or more computing systems consistent therewith, unless otherwise indicated or the context clearly indicates otherwise.

Computing system 400 comprises components coupled via one or more communication channels (e.g. bus 401) including one or more general or special purpose processors 402, such as a Pentium®, Centrino®, Power PC®, digital signal processor (“DSP”), and so on. System 400 components also include one or more input devices 403 (such as a mouse, keyboard, microphone, pen, and so on), and one or more output devices 404, such as a suitable display, speakers, actuators, and so on, in accordance with a particular application.

System 400 also includes a computer readable storage media reader 405 coupled to a computer readable storage medium 406, such as a storage/memory device or hard or removable storage/memory media; such devices or media are further indicated separately as storage 408 and memory 409, which may include hard disk variants, floppy/compact disk variants, digital versatile disk (“DVD”) variants, smart cards, partially or fully hardened removable media, read only memory, random access memory, cache memory, and so on, in accordance with the requirements of a particular implementation. One or more suitable communication interfaces 407 may also be included, such as a modem, DSL, infrared, RF or other suitable transceiver, and so on for providing inter-device communication directly or via one or more suitable private or public networks or other components that can include but are not limited to those already discussed.

Working memory 410 further includes operating system (“OS”) 411, and may include one or more of the remaining illustrated components in accordance with one or more of a particular device, examples provided herein for illustrative purposes, or the requirements of a particular application. Learning map 412, pattern determining engine 413 and content determining engine 414 may, for example, be operable in substantially the same manner as was already discussed. Working memory of one or more devices may also include other program(s) 415, which may similarly be stored or loaded therein during use.

The particular OS may vary in accordance with a particular device, features or other aspects in accordance with a particular application, e.g., using Windows, WindowsCE, Mac, Linux, Unix, a proprietary OS, and so on. Various programming languages or other tools may also be utilized, such as those compatible with C variants (e.g., C++, C#), the Java 2 Platform, Enterprise Edition (“J2EE”) or other programming languages. Such working memory components may, for example, include one or more of applications, add-ons, applets, servlets, custom software and so on for implementing functionality including, but not limited to, the examples discussed elsewhere herein. Other programs 415 may, for example, include one or more of security, compression, synchronization, backup systems, groupware, networking, or browsing code, assessment delivery/conducting code for receiving or responding to resulting items or other information, and so on, including but not limited to those discussed elsewhere herein.

When implemented in software, one or more of system 100a and 100b or other components may be communicated transitionally or more persistently from local or remote storage to memory (SRAM, cache memory, etc.) for execution, or another suitable mechanism may be utilized, and one or more component portions may be implemented in compiled or interpretive form. Input, intermediate or resulting data or functional elements may further reside more transitionally or more persistently in a storage media, cache or other volatile or non-volatile memory, (e.g., storage device 408 or memory 409) in accordance with the requirements of a particular implementation.

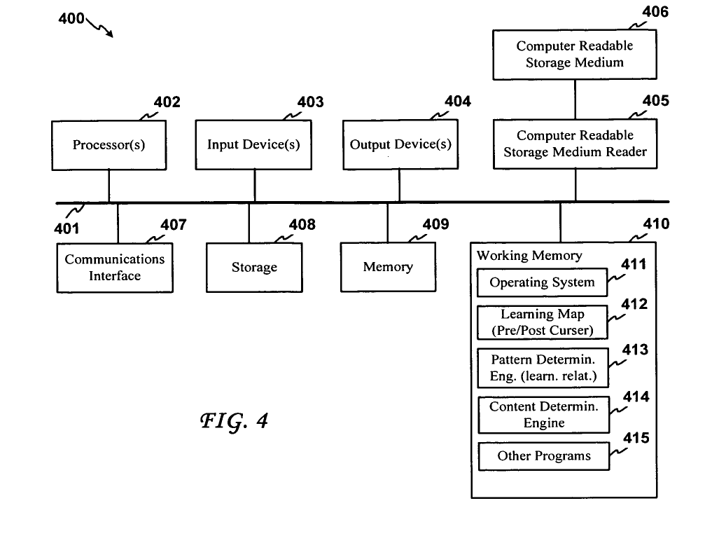

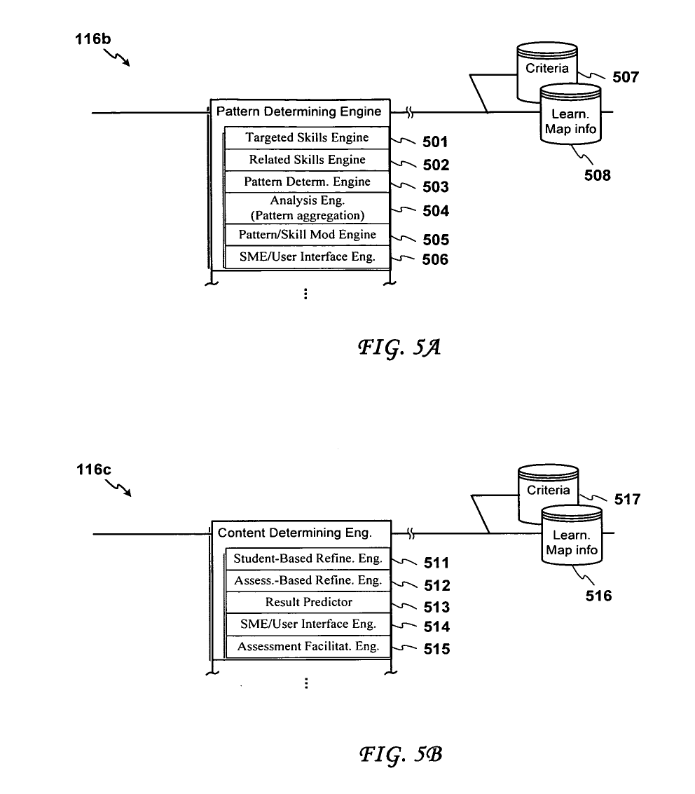

Continuing with FIG. 5a, pattern determining engine 116b may include targeted skills engine 501, related skills engine 502, pattern determining engine 503, analysis engine 504, pattern/skill modification engine 505 and user interface engine 506. Skills engine 501 and related skills engine 502 are responsive to stored or received assessment criteria 507 for determining one or more skills to be assessed in conjunction with at least one item. The skills may, for example, include at least one of target skills and related skills respectively, which related skills may be determined as corresponding with a learning order skill relationship with a target skill or at least one related skill. The criteria may include a learning map 508 or other learning criteria, and may include a precursor/postcursor relationship for determining the learning order relation.

Pattern determining engine 503 is responsive to skill selection, e.g., by engines 501 and 502, for determining at least one item pattern, from among item patterns corresponding to each of the determined skills. The item patterns may, for example, correspond to a compatible item pattern type that is the same or similar or may be modified to be compatible with a given type or combined with the other determined item patterns. Analysis engine 504 further provides for combining the determined item patterns, or if a suitable combination cannot be determined (e.g., due to stimulus or response pattern criteria incompatibility, exceeding a processing time limit, or other predetermined criteria), for initiating pattern/skill modification engine (modification engine) 505.

Modification engine 505 further provides for removing criteria corresponding to at least one item pattern in a predetermined order, and initiating analysis engine 504 to re-attempt the combination (e.g., presentation or other non-skill-assessing criteria first, or further in a predetermined order). If a suitable combination may not be made, then analysis engine 504 initiates modification engine 505, which provides for removing the incompatible item pattern(s) and the skill from a resultant item, and documenting such removal. If a suitable combination requires removal of skill-assessing criteria, then modification engine 505 provides for either removing the incompatible item pattern and skill and documenting such removal, or removing the offending item pattern criteria and documenting a resultant loss in assessment accuracy. Engine 505 also provides for initiating interface engine 506 to alert a user of such removal or provide such documentation. Interface engine 506 further provides a user interface for enabling a user to input criteria, override the above automatic (e.g., programmatic) operation, enter item pattern information, and so on, in accordance with the requirements of a particular implementation.

FIG. 5b further illustrates how content determining engine 116c may include student-based refinement engine 511, assessment based refinement engine 512, result predictor 513, SME/User interface engine 514 and assessment facilitation engine 515. Student-based refinement engine (student refinement engine) 511 provides for receiving at least one item (e.g., formed by pattern determining engine 116b), and determining modifications to item portions of the item corresponding to actual or probable characteristics or other criteria 517 specific to a student or at least a substantial portion of a student group. Probable characteristics may, for example, include comparing prior student/group characteristics of a same group or similar group, or estimating or combining available information (such as learning map information 516), and so on, so long as the accuracy of assessment may remain acceptable according to a particular implementation. Acceptability may, for example, include producing an assessment the measurement of which may be verified or validated. Substantiality may, for example, be determined as a predetermined fixed, weighted or adjustable percentage or otherwise in accordance with requirements of a particular implementation.

Assessment-based refinement engine 512 further provides for receiving at least one item (e.g., formed by pattern determining engine 116b), and determining modifications to item portions of the item corresponding to actual or probable characteristics or other criteria specific to an assessment in which the item may be used. Assessment-based refinement engine 512 may, for example, operate in conjunction with criteria such as that discussed in conjunction with content determining engine or elsewhere herein, and may be operable in a similar manner.

Result predictor 513 provides for determining assessment results that are likely to result from assessing a particular student or student group. Result predictor 513 may, for example, receive a learning map corresponding to a student or student group being assessed and determine that content in the item is similar to content in items with bias against a student sub group that is a part of the student group. Assessment based refinement engine 512 may then, for example, determine a change in the item that would make it dissimilar from biased items, and either automatically or through SME approval via SME/User Interface engine 514, create a new item based on the original item, which is predicted to be non-biased.

SME/User interface engine 514 provides for alerting a user as to automatic or prior user-assisted operation or providing the user with documentation as to such operation or results thereof. Alerts may be given, for example, where criteria that is to be implemented conflicts and cannot be sufficiently resolved automatically. Content determination and SME/User Interface engine 514 also provide for user intervention, for example, as was already discussed. (Results predictor 513 may also support such operation.)

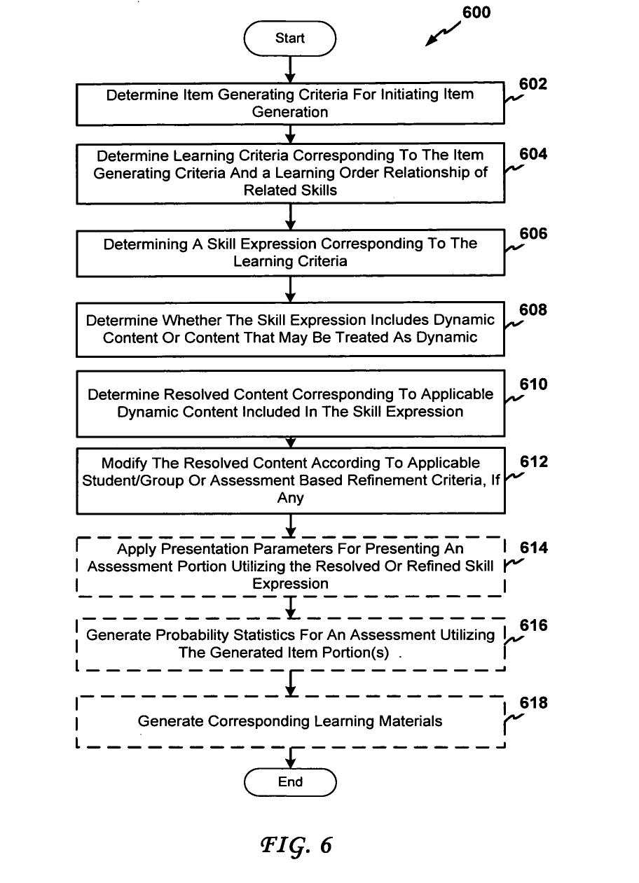

Turning now to FIG. 6, a patterned response method 600 is illustrated according to an embodiment of the invention that may, for example, be performed automatically by an item generation engine (generating engine), or with user assistance (e.g., see above). In block 602 the generating engine determines item generating criteria for initiating item generation. Such criteria may, for example, be provided by a user or external system, determined according to criteria determining parameters, retrieved from storage, or some combination thereof. The item generating criteria may, for example, include initiation of item generation by a user/device, a standard or other assessment specification information (e.g., see above), or a pre-existing learning map portion (or other learning criteria) corresponding to the assessment, a prior assessment, student or student group criteria (e.g., infirmity, learning information, learning information to be spread across a student group or combined for use with the student group, and so on). Item generation criteria may also include an expected student performance of a student or student group, among other combinable alternatives.

In block 604, the generating engine determines learning criteria corresponding to the item generating criteria and a learning order relationship of related skills. The learning order relationship may, for example, be implemented as pre/post cursor relationships of learning targets (e.g., a target skill and related skills), which learning targets may be included in a learning map portion. Learning targets may further be distributed according depths of knowledge corresponding to a skill.

In block 606, the generating engine determines at least one skill expression corresponding to the item generating criteria. The skill expression may, for example, include a composite item pattern of a target skill and related skills that may be formed as an aggregate item pattern resolution (e.g., simultaneous solution). As was discussed above, however, a suitable resolution may not be found to all item pattern criteria of all determined skills. For example, item generation criteria may provide for limited processing (e.g., limited processing time) according to which a solution may not (yet) be found. The measurement accuracy of an assessment may also be reduced by resultant item characteristics such as duplication of an expected response value corresponding to two or more skills. Therefore, unless otherwise accommodated (e.g., by documenting a resultant uncertainty or other accuracy reduction, generation criteria may disallow such duplication or other undesirable results. Further unsuitable resolutions may, for example, include expected response sets which create outliers in the set (e.g., expected response set “1”,“3”,“4”,“7”,“99”, where “99” has 2 digits instead of 1). A solution may also fail to exist in the case of aggregation resolution, among other considerations. In such cases, various embodiments provide for careful relaxation of criteria. One embodiment, for example, provides for relaxing criteria beginning with generation criteria that is non-substantive (e.g., allowing but documenting duplicate expected response values, and so on), before relaxing substantive values or excluding a skill representation in a resulting item.

In block 608, the generating engine determines whether the skill expression includes dynamic content or content that may be treated as dynamic (e.g., using one or more of parsing, search and replace, contextual/format analysis, artificial intelligence or other suitable techniques. The generating engine may, for example, determine an inclusion of positional or content predetermined variables or other skill expression information as being dynamic and capable of replacement, association, resolving or other modification (e.g., form, multimedia attributes, difficulty, and so on, or some combination). In block 610, the generating engine determines resolved content corresponding to applicable dynamic content included in the skill expression, and may further replace or otherwise resolve applicable dynamic content with its resolving terms, images, audio, other multimedia or other applicable content.

In block 612, the generating engine modifies the resolved content according to applicable student, student group or assessment based refinement criteria, if any of such content is to be modified. Student or student group refinement criteria may, for example be provided by an applicable learning map, student history or substantially any other source of demographic, infirmity, advancement or other student/group characteristics that may be used to distract, avoid distracting, specifically assess or avoid specifically assessing the student/group using a resulting item (e.g., see above). Assessment based refinement criteria may, for example, be provided by a generating engine comparing or otherwise analyzing content portions of the same or different items or different versions of the same or different items (e.g., in a staggered distribution, comparative sampling or other version varying assessment utilization). As with other resolving or refinement criteria, assessment based refinement criteria may be implemented on content that may or may not include strictly dynamic content, such as variables or links, as well as on item portions that may be otherwise determined by one or more of the same or different generating engines, manual creation or other sources. Assessment based refinement criteria may also be used to distract, avoid distracting, and so on, but is generally directed at item portion characteristics relating to other than the specific skill(s) for which a response is to be provided according to the call of a stimulus (substantive content).

In block 614, the generating engine applies presentation parameters for presenting an assessment portion utilizing the resolved expression (resolved item) or refined expression (if refinement criteria has been applied). In block 616, the generating engine determines probability statistics for an assessment utilizing the generated item portions, and in block 618, the generating engine may generate, or link to, learning materials corresponding to the particular skills represented by one or more resulting or included items.

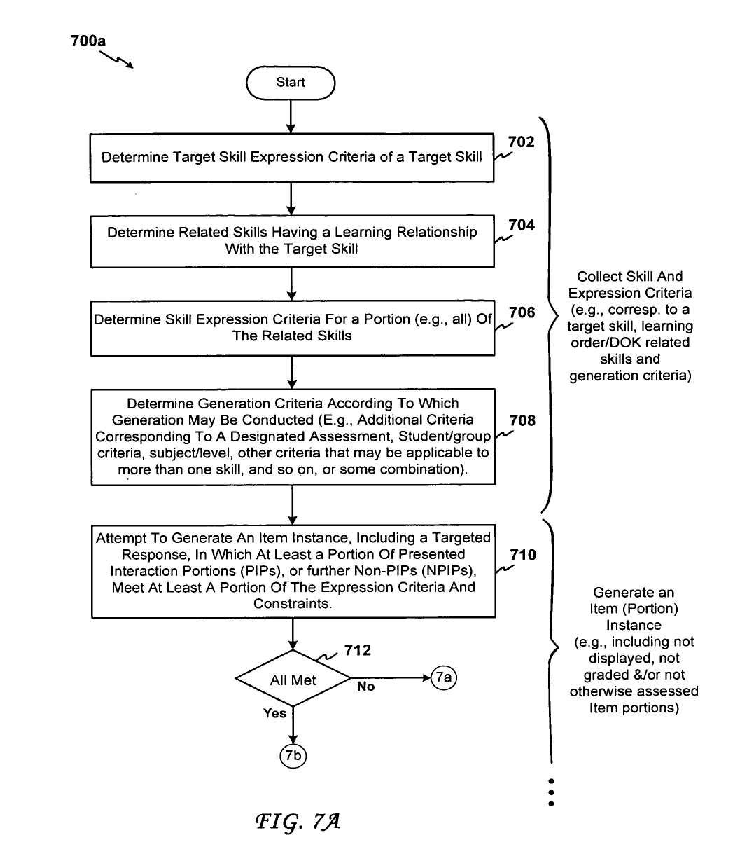

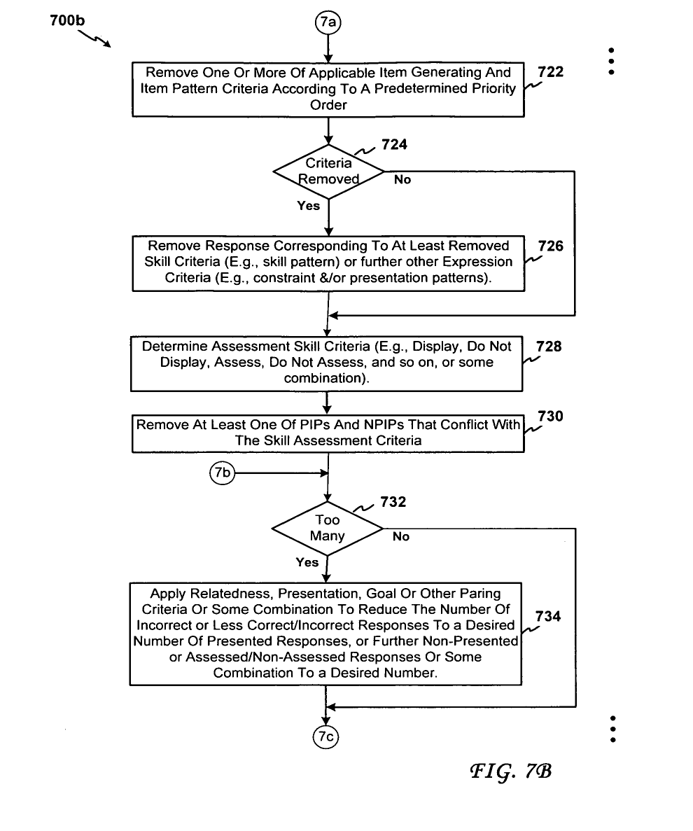

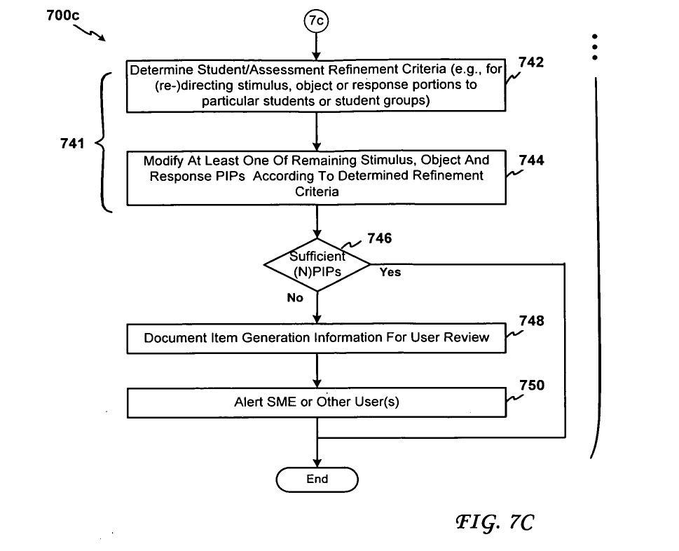

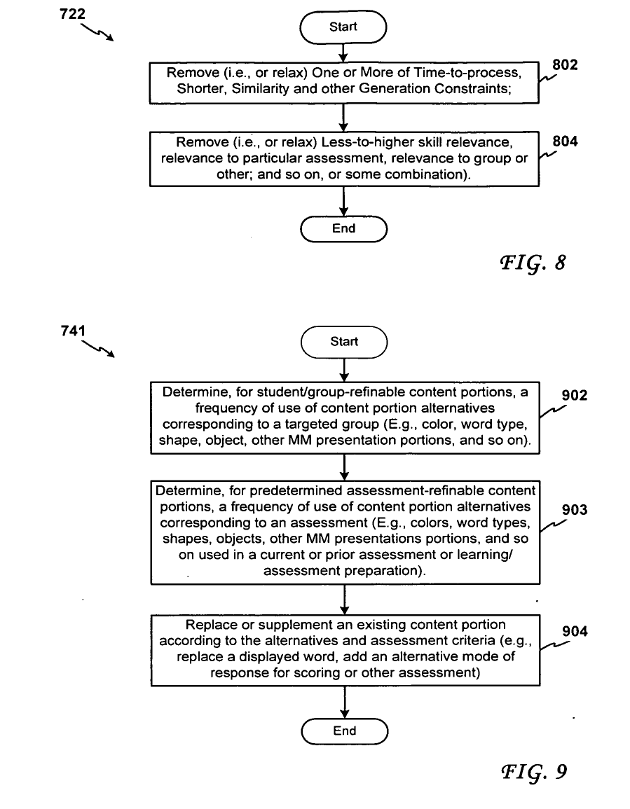

FIGS. 7a through 7c illustrate a further patterned response method according to an embodiment of the invention, exemplary details for which are further illustrated in FIGS. 8 and 9. As with method 600, method 700 may, for example, be performed by one or more generating engines that may further perform the method automatically (e.g., programmatically) or with user intervention.

Beginning with FIG. 7a, in block 702, a generating engine determines target skill expression criteria of a target skill. As with method 600, the target skill may be determined according to received criteria, and the expression may include an item pattern corresponding to the target skill. The target skill may further be determined in conjunction with a learning map. In block 704, the generating engine determines one or more related skills corresponding to the target skill. The related skills in one embodiment are determined according to a learning relationship defined by precursor and postcursor relationship probabilities according to which the skills are coupled in a learning map. The related skills may also be determined in accordance with selection criteria including a predetermined number, degree of relationship with the target skill, subject, level or other degree of knowledge, and so on, or some combination (e.g., see above). In block 706, the generating engine determines skill expression criteria for a portion (typically all) of the related skills.

In block 708, the generating engine determines generation criteria according to which item generation may be conducted. Generation criteria may, for example, correspond to a designated assessment, student/student group criteria, subject/level, other criteria that may be applicable to one skill or more than one skill, and so on, or some combination (e.g., see above). The generation criteria may, for example, include assignment of the target skill as a stimulus and response and the remaining skills as responses, processing time for aggregating the expression criteria, digit, word, graphic or other multimedia use, length, distance, complexity, similarity/dissimilarity, and so on, or some combination.

In block 710, the generating engine attempts to generate an item instance, including a targeted response, in which at least a portion of presented interaction portions (PIPs) or further non-presented interaction portions (NPIPs) meet a portion (preferably all) of the expression criteria and generation criteria. If, in block 712, all of the expression criteria may be met (or “resolved”), then the method continues with block 732 (FIG. 7b); otherwise, the method continues with block 722 of FIG. 7b. (Application of the generation criteria may, for example include setting a maximum processing time for resolving the expression criteria, providing for only one response including a given response value, assuring a minimum number of responses, and so on, or some combination. Therefore, resolution may not be achieved in one embodiment if an absolute failure to meet all expression criteria exists or resolution may not be achieved within the maximum processing time.

Continuing now with FIG. 7b, in block 722, the generating engine removes (e.g., explicitly removes or relaxes) one or more or successive ones of the applicable expression and generation criteria according to a priority order (e.g., first generation criteria from least impacting to most impacting, and then any expression criteria). See also FIG. 8. If, in block 724, expression criteria is removed, then the method proceeds with block 726; otherwise the method proceeds with block 728.

In block 726, the generating engine removes responses corresponding to at least a removed expression criteria, for example, a stimulus or expected response pattern portion. In block 728, the generating engine determines skill assessment criteria. Such criteria may, for example, include, for a resulting item portion: display, do not display, assess, do not assess, and so on. In block 730, the generating engine in one embodiment removes PIPs and NPIPs that conflict with skill assessment criteria (if any). In another embodiment, such removal may be subject to various removal criteria, such as whether a predetermined number of PIPs will remain. For example, a repeated response value generation criteria may be superseded by a removal criteria (e.g., minimum number of remaining PIPs). Further criteria may include documenting or alerting an SME or other user as to the conditions or implementation of removal.

If, in block 732, the number of resulting expected presented or not presented responses exceeds a response maximum, then the method proceeds to block 734; otherwise, the method proceeds with block 742 (FIG. 7c). In block 734, the number of presented or not presented responses exceeding a maximum number are removed. Removal criteria may, for example, include relatedness, presentation, assessment goal(s), and so on. (Such responses may be generated in a more absolute manner as correct or incorrect, or in a more graduated manner in which correct aspects of a less than absolutely correct student response may be credited or incorrect aspects may be deducted; various granularities of correctness, incorrectness, substantial correctness or substantial incorrectness may also be used.)

An example of sub-process 722 is shown in greater detail in the method embodiment of FIG. 8. In step 802, one or more of time-to-process, length, similarity, or other generation constraints are removed (i.e., or relaxed) from the skill expression. In step 804, one or more of lesser-to-greater skill relevance, relevance to particular assessment, relevance to group, or other criteria, or some combination thereof, are removed (or relaxed) from the skill expression.

Continuing with FIG. 7c, in block 742, the generating engine determines student/assessment refinement criteria, and in block 744, the generating engine modifies remaining PIPs in accordance with the determined refinement criteria, examples of which are provided by the FIG. 9 embodiment.

If, in block 746, an insufficient number (or quality) of PIPs or NPIPs remain in a resulting item, then the generating engine documents item generation information for user review in block 748 and alerts a corresponding SME or other user as to the insufficient number in block 750.

An example sub-process 741 is shown in greater detail in the method embodiment of FIG. 9. In step 902, frequency of use of content portion alternatives corresponding to a targeted group are determined for student/group-refinable content portions. In step 903, frequency of use of content portion alternatives corresponding to an assessment are determined for predetermined assessment-refinable content portions. Finally, in step 904, existing content portions are replaced or supplemented according to the alternatives and assessment criteria.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention.

What is claimed is:

1. A computerized patterned response method for generating, either automatically or in a user-assisted manner, assessment items or portions thereof, the method comprising:
receiving item generating criteria;
selecting a target skill and related skills corresponding to the item generating criteria and corresponding to a learning order relationship between the target skill and related skills;
generating a preliminary item pattern expression corresponding to the target skill and the related skills; and
resolving the preliminary item pattern expression to form a resolved item pattern expression.

2. The method of claim 1, wherein the item generating criteria comprises one or more of student/group, subject, level, goal, assessment specification, syllabus, depth of knowledge, prior assessment, time to learn, time since learning/assessment, likelihood of forgetting, predetermined item patterns for a target skill and one or more related skills, explicit expression of a target skill and one or more related skills, and learning materials.

3. The method of claim 1, wherein said criteria is provided by one of a user, an external system, or retrieved from storage.

4. The method of claim 1, wherein the learning order relationship between the target skill and the related skill comprises one or more of precursor and postcursor relationships, the degree of relatedness, and comparisons of the depth of knowledge of the target skill and the related skills.

5. The method of claim 1, wherein said resolving step comprises resolving dynamic content of the preliminary item pattern expression and refining item pattern expression content according to at least one of student-based refinement criteria, student group-based refinement criteria, and assessment-based refinement criteria.

6. The method of claim 1, wherein the assessment item is at least one item selected from the group comprising selected response, graphing, matching, short answer, essay, constrained constructed response items, multimedia, gaming, performance of a job/educational function, and performance of assessable assessment-subject actions or inactions.

7. The method of claim 1, wherein the item generating criteria includes a learning map designating precursor and postcursor relationships between a plurality of learning targets and selecting a target skill and related skills comprises excluding at least one skill that is a precursor of a selected skill.

8. The method of claim 1, wherein the item pattern includes criteria corresponding to a stimulus, response, presentation, and response evaluation criteria associated with a target skill.

9. The method of claim 8, wherein the stimulus criteria may be used to determine a stimulus of the item.

10. The method of claim 8, wherein the response criteria may be used to determine one or more selectable response alternatives, constrained constructed responses, student interactions, or responsive student actions.

11. The method of claim 8, wherein the presentation criteria may be used to determine (a) whether or not stimulus or response portions may be explicitly or implicitly presented to a student or student group or (b) the format of presentation to the student or student group.

12. The method of claim 8, wherein the response evaluation criteria may include one or more response evaluators that may be applied to an assessment subject's item response to produce one or more scores.

13. The method of claim 1, wherein each item pattern includes:
a stimulus pattern from which a stimulus may be resolved, the stimulus comprising an initiating occurrence that may produce a measurable assessment of an assessment subject response;
an expected response pattern from which one or more expected responses may be resolved, the expected response comprising an assessment subject's thought or action for which a corresponding measurable assessment may be produced;
presentation criteria for resolving an item pattern to provide a manner of presenting, partially presenting, or not presenting a corresponding stimulus or response portion, an item portion, or some combination thereof; and
response evaluation criteria providing methods and instructions for evaluating assessment subjects' responses to items to derive their meaning.

14. The method of claim 13, wherein the presentation criteria comprises presentation pattern, presentation constraints, and presentation templates.

15. The method of claim 13, wherein the response evaluation criteria comprises response evaluation pattern, response evaluation constraints, and response evaluation templates.

16. The method of claim 1, further comprising relaxing one or more of the applicable criteria where a sufficient number of item portions may not be determined to meet the aggregate of criteria according to at least one predetermined condition.

17. The method of claim 16, wherein the predetermined condition comprises processing time.

18. The method of claim 16, further comprising removing item portions that represent skills for which now relaxed criteria corresponding to the skill are no longer applicable.

19. The method of claim 16 further comprising documenting as to item portion removal or successful/unsuccessful item portion generation.

20. The method of claim 16 further comprising providing an alerting as to item portion removal or successful/unsuccessful item portion generation.

21. A computerized patterned response system for generating, either automatically or in a user-assisted manner, assessment items, the system comprising a computer coupled with memory storing pattern response generating program code executable by said computer and including instructions defining a skill determining engine for determining a target skill and related skills according to a learning order relationship, a skill expression engine adapted to generate a skill expression corresponding to at least one of said target skill and said related skills, a content engine adapted to modify the skill expression in view of predetermined refinement criteria, and a learning map providing data representing a plurality of learning targets and the relationships therebetween, wherein the learning order relationships between the target skill and the related skills are determined from said learning map.

22. A patterned response system for generating, either automatically or in a user-assisted manner, assessment items, said system comprising:
means for determining item generating criteria;
means for determining a target skill and related skills corresponding to the item generating criteria and a learning order relationship;
means for determining an item pattern expression corresponding to the target skill and the related skills; and
means for resolving the item pattern expression to form a resolved item pattern expression.

23. The system according to claim 22, further comprising means for refining item pattern expression content according to at least one of student-based refinement criteria, student group-based refinement criteria, and assessment-based refinement criteria to form an item instance.

24. A computer-readable medium having stored thereon computer-executable instructions for implementing a patterned response method for generating, either automatically or in a user-assisted manner, assessment items, wherein the instructions comprise instructions for:
determining item generating criteria;
determining a target skill and related skills corresponding to the item generating criteria and a learning order relationship;
determining an item pattern expression corresponding to the target skill and the related skills; and
resolving the item pattern expression to form a resolved item pattern expression.

25. The computer-readable medium of claim 24, said instructions further comprising instructions for refining the item pattern expression content according to at least one of student-based refinement criteria, student group-based refinement criteria, and assessment-based refinement criteria to form an item instance.

26. A computerized assessment provider system comprising:
an assessment generation system for generating assessment portions and comprising an item generation engine for generating assessment items or portions thereof, said item generation engine comprising a learning map comprising data representing a plurality of learning targets and the relationships therebetween, a skill/pattern determining engine for determining a learning target skill to assess and for determining from said learning map one or more skills related to the target skill, and a content determining engine for modifying item content in one or more item portions to conform to one or more refinement criteria;
an item producing device in communication with at least said assessment generation system for generating items in a format that can be presented to an assessment subject; and
a subject assessment system for analyzing assessment responses by assessment subjects, said subject assessment system being in communication with said assessment generation system, wherein information relating to analysis of assessment responses is communicated from said subject assessment system to said assessment generation system and is used by said assessment generation system for refining current or future assessment items.

27. The system according to claim 26, wherein the refinement criteria comprises criteria for rendering item content more consistent with characteristics of a particular student or particular student group.

28. The system according to claim 27, wherein the characteristics of a particular student or particular student group comprise one or more of demographic characteristics of a particular student or particular student group and infirmity characteristics of a particular student or particular student group.

29. The system according to claim 26, wherein said item producing device comprises at least one of a printer, a brail generator, or a multimedia renderer adapted for rendering hard copy assessment materials.

30. The system according to claim 26, wherein said item producing device comprises means for rendering assessment materials in a format that is electronically transmittable.

31. The system according to claim 26, wherein said skill/pattern determining engine comprises:
a targeted skills engine and a related skills engine responsive to stored or received assessment criteria for determining one or more skills to be assessed in conjunction with at least one item, wherein the skills include at least one of target skills and related skills determined as corresponding with a learning order skill relationship with a target skill or at least one other related skill;
a pattern determining engine responsive to a skill determination made by said targeted skills engine and said related skills engine for determining at least one item pattern from among item patterns corresponding to each of the determined skills;
an analysis engine which provides for combining the item patterns determined by said pattern determining engine if a suitable combination can be determined;
a pattern/skill modification engine initiated by said analysis engine if a suitable combination of item patterns cannot be determined, said pattern/skill modification engine being adapted to remove criteria corresponding to at least one item pattern in a predetermined order and to initiate said analysis engine to re-attempt the combination of item patterns, wherein if a suitable combination may still not be made after removal of criteria by said pattern/skill modification engine, then said analysis engine initiates said pattern/skill modification engine to remove one or more incompatible item patterns and corresponding skills from a resultant item; and
a user interface engine initiated by said pattern/skill modification engine and adapted to enable user inputs in response to modifications implemented by said pattern skill modification engine.

32. The system according to claim 26, wherein said content determining engine comprises:
a student-based refinement engine adapted to receive at least one item formed by said skill/pattern determining engine and determine modifications to one or more item portions corresponding to characteristics specific to a student or at least a substantial portion of a student group;
an assessment-based refinement engine adapted to receive at least one item formed by said skill/pattern determining engine and determine modifications to one or more item portions corresponding to characteristics specific to an assessment in which the item may be used;
a result predictor adapted to determine assessment results that are likely to result from assessing a particular student or student group and to identify one or more items or item portions that may be biased against a particular student or student group; and
a user interface engine adapted to notify a user as to at least one of modifications determined by said student-based refinement engine or said assessment-based refinement engine and bias determined by said result predictor.

33. The system according to claim 26, further comprising an item response receiving device in communication with at least said subject assessment system for receiving assessment responses by assessment subjects and converting the received responses into a format that can be analyzed by said subject assessment system.

34. The system according to claim 33, wherein said item response receiving device comprises one or more of a scanner and a renderer.

35. The system according to claim 26, wherein said item producing device comprises one or more of printer, an audio presentation device, a video presentation device, and an audio/video renderer.

36. A computerized patterned response method for generating, either automatically or in a user-assisted manner, assessment items or portions thereof, the method comprising:
determining item generating criteria for initiating item generation;
determining learning criteria corresponding to the item generating criteria and a learning order relationship of related skills;
determining a skill expression corresponding to the item generating criteria;
determining whether the skill expression includes dynamic content or content that may be treated as dynamic;
determining resolved content corresponding to applicable dynamic content included in the skill expression;
determining whether the resolved content should be modified according to applicable student, student group, or assessment based refinement criteria and modifying any resolved content requiring modification;
determining item presentation parameters; and
applying the item presentation parameters for presenting an assessment portion utilizing the resolved content or refined content if resolved content has been modified in accordance with refinement criteria to create one or more generated item portions.

37. The method of claim 36, further comprising determining probability statistics for an assessment utilizing the generated item portions.

38. The method of claim 36, further comprising generating, or linking to, learning materials corresponding to the particular skills represented by the generated item portions.
